(19) United States
(12) Patent Application Publication
(10) Pub. No.: US 2022/0333809 A1
(43) Pub. Date: Oct. 20, 2022

(54) TEMPERATURE SETTING DEVICE, TEMPERATURE SETTING METHOD, AND STORAGE MEDIUM

(71) Applicant: Mitsubishi Electric Corporation, Tokyo (JP)

(72) Inventors: Hirohiko HIGUCHI, Tokyo (JP); Hitoshi YOSHIZAWA, Tokyo (JP); Kyoko YAJIMA, Tokyo (JP); Shohei YOSHIDA, Tokyo (JP); Hiroshi MORIYASU, Tokyo (JP); Makoto KATSUKURA, Tokyo (JP)

(73) Assignee: Mitsubishi Electric Corporation, Tokyo (JP)

(21) Appl. No.: 17/859,023

(22) Filed: Jul. 7, 2022

Related U.S. Application Data
(63) Continuation of application No. PCT/JP2020/003703, filed on Jan. 31, 2020.

(51) Int. Cl. F24F 11/523; F24F 11/63; F24F 11/526

(52) U.S. Cl. CPC F24F 11/523; F24F 11/63; F24F 11/526

(57) ABSTRACT

A temperature setting device includes: a contour map display processing unit to display a contour map representing a temperature distribution in a room where an air conditioner is installed on a screen in accordance with display data of the contour map; a coordinates acquiring unit to acquire, when contact with the contour map displayed on the screen is detected, position coordinates indicating a position of the contact on the contour map as position coordinates indicating a point at which a set temperature is to be changed; and a control signal outputting unit to output, to a control device of the air conditioner, a first control signal giving an instruction to lower the set temperature at the point or a second control signal giving an instruction to raise the set temperature at the point, the point being indicated by the position coordinates acquired by the coordinates acquiring unit.

### CROSS-REFERENCE TO RELATED APPLICATION

The present application is a continuation of International Patent Application PCT/JP2020/003703, filed Jan. 31, 2020, the entire contents of which are incorporated herein by reference.

### TECHNICAL FIELD

The present disclosure relates to a temperature setting device, a temperature setting method, and a storage medium storing temperature setting program for outputting a control signal to a control device of an air conditioner.

### BACKGROUND ART

In conventional temperature setting devices for air conditioners, one set temperature is set to one air conditioner (see Patent Literature 1).

### CITATION LIST

### Patent Literature

Patent Literature 1: JP 2017-62837 A

### SUMMARY OF INVENTION

### Technical Problem

Typically, the temperature in a room in which an air conditioner is installed is not uniformly brought to a set temperature. Meanwhile, a user of the room may have a demand to keep a temperature at a desired point in the room at the set temperature. The conventional temperature setting devices for air conditioners have a disadvantage that such a demand cannot be met.

The present disclosure has been made to solve the disadvantage as the above, and an object of the present disclosure is to obtain a temperature setting device, a temperature setting method, and a temperature setting program capable of setting a temperature at a desired point in a room in which an air conditioner is installed.

### Solution to Problem

A temperature setting device according to the present invention includes processing circuitry to display a contour map representing a temperature distribution in a room where an air conditioner is installed on a screen in accordance with display data of the contour map, to acquire, when contact with the contour map displayed on the screen is detected, position coordinates indicating a position of the contact on the contour map as position coordinates indicating a point in the room at which a set temperature is to be changed, to perform output of, to a control device of the air conditioner, a first control signal giving an instruction to lower the set temperature at the point in the room or a second control signal giving an instruction to raise the set temperature at the point in the room, the point being indicated by the position coordinates, to display, on the screen, a first operation icon for accepting an operation of lowering the set temperature at the point in the room and a second operation icon for accepting an operation of raising the set temperature at the point in the room, the point being indicated by the position coordinates, to accept the operation of lowering the set temperature when contact with a display area of the first operation icon on the screen is detected and to accept the operation of raising the set temperature when contact with a display area of the second operation icon on the screen is detected, and to estimate a sensible temperature felt by a user on a basis of the operation of lowering the set temperature or the operation of raising the set temperature. In the output, the processing circuitry outputs the first control signal to the control device when the operation of lowering the set temperature is accepted by the temperature setting device and outputs the second control signal to the control device when the operation of raising the set temperature is accepted by the temperature setting device, the processing circuitry displays a temperature changing point icon representing the point in the room indicated by the position coordinates to be superimposed on the contour map and displays each of the first operation icon and the second operation icon to be superimposed on the contour map, the processing circuitry displays, as the temperature changing point icon, an icon in which, in a display area of the temperature changing point icon, a display area on the point in the room indicated by the position coordinates is transparent to be superimposed on the contour map or a frame-shaped icon in which, in a display area of the temperature changing point icon, a display area on the point in the room indicated by the position coordinates is hollowed out to be superimposed on the contour map, and the processing circuitry changes a color of the temperature changing point icon when the operation of lowering the set temperature is accepted by the temperature setting device or the operation of raising the set temperature is accepted by the temperature setting device. The processing circuitry displays a sensible temperature icon indicating the sensible temperature estimated in the display area on the point in the room indicated by the position coordinates.

### Advantageous Effects of Invention

According to the present disclosure, it is possible to set a temperature at a desired point in a room where an air conditioner is installed.

### BRIEF DESCRIPTION OF DRAWINGS

FIG. 1 is a configuration diagram illustrating an air conditioning system 1 including a temperature setting device 5 according to a first embodiment.

FIG. 2 is a hardware configuration diagram illustrating the hardware of the temperature setting device 5 according to the first embodiment.

FIG. 3 is a hardware configuration diagram of a computer in a case where a pan of the temperature setting device 5 is implemented by software, firmware, or the like.

FIG. 4 is a flowchart illustrating a processing procedure performed in the temperature setting device 5.

FIG. 5 is an explanatory diagram illustrating an example of a contour map displayed by a contour map display processing unit 12.

FIG. 6 is an explanatory diagram illustrating an example of a temperature changing point icon displayed by an icon display processing unit 14.

FIG. 7 is an explanatory diagram illustrating an example of a first operation icon and an example of a second operation icon displayed by the icon display processing unit 14.

FIG. 8 is a configuration diagram illustrating an air conditioning system 1 including a temperature setting device 5 according to a second embodiment.

FIG. 9 is a hardware configuration diagram illustrating the hardware of the temperature setting device 5 according to the second embodiment.

FIG. 10 is an explanatory diagram illustrating an example of sensible temperature icons indicated by graphic data stored in an icon storage unit 42.

FIG. 11 is an explanatory diagram illustrating a state in which a sensible temperature icon transitions by an operation by a user.

FIG. 12 is a configuration diagram illustrating an air conditioning system 1 including a temperature setting device 5 according to a third embodiment.

FIG. 13 is a configuration diagram illustrating an air conditioning system 1 including a temperature setting device 5 according to a fourth embodiment.

FIG. 14 is an explanatory diagram illustrating an example of an elapsed time icon displayed by an icon display processing unit 45.

FIG. 15 is a configuration diagram illustrating an air conditioning system 1 including a temperature setting device 5 according to a fifth embodiment.

FIG. 16 is a hardware configuration diagram illustrating the hardware of the temperature setting device 5 according to the fifth embodiment.

FIG. 17 is an explanatory diagram illustrating a drag operation of moving a temperature changing point icon.

FIG. 18 is a configuration diagram illustrating an air conditioning system 1 including a temperature setting device 5 according to a sixth embodiment.

FIG. 19 is a hardware configuration diagram illustrating the hardware of the temperature setting device 5 according to the sixth embodiment.

FIG. 20 is an explanatory diagram illustrating a drag operation of scaling a temperature changing point icon.

FIG. 21 is an explanatory diagram illustrating a plurality of temperature changing point icons, a plurality of first operation icons, and a plurality of second operation icons displayed by an icon display processing unit 14.

FIG. 22 is a configuration diagram illustrating an air conditioning system 1 including a temperature setting device 5 according to an eighth embodiment.

FIG. 23 is a hardware configuration diagram illustrating the hardware of the temperature setting device 5 according to the eighth embodiment.

FIG. 24 is an explanatory diagram illustrating an example of the contour map displayed by the contour map display processing unit 12.

FIG. 25 is an explanatory diagram illustrating examples of the temperature changing point icon.

FIG. 26 is an explanatory diagram illustrating examples of the sensible temperature icon.

### DESCRIPTION OF EMBODIMENTS

To describe the present disclosure further in detail, embodiments for carrying out the present disclosure will be described below along with the accompanying drawings.

### First Embodiment

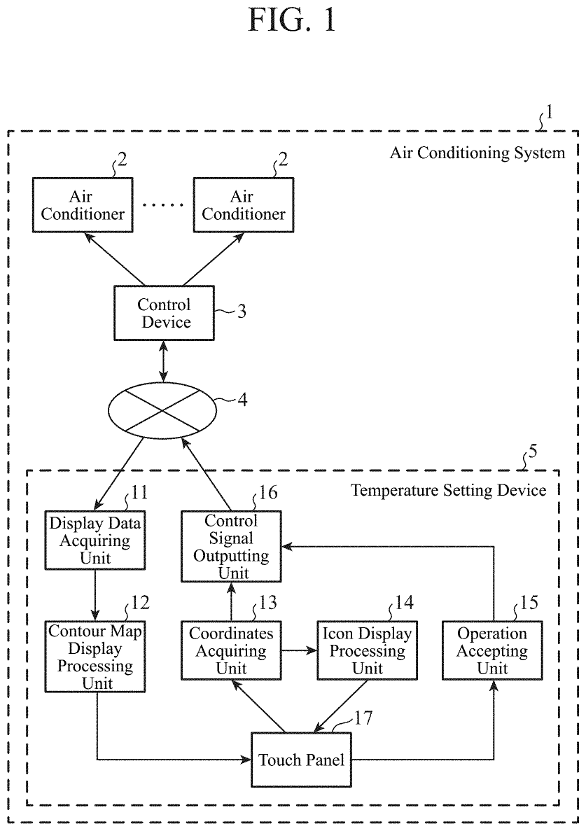

FIG. 1 is a configuration diagram illustrating an air conditioning system 1 including a temperature setting device 5 according to a first embodiment.

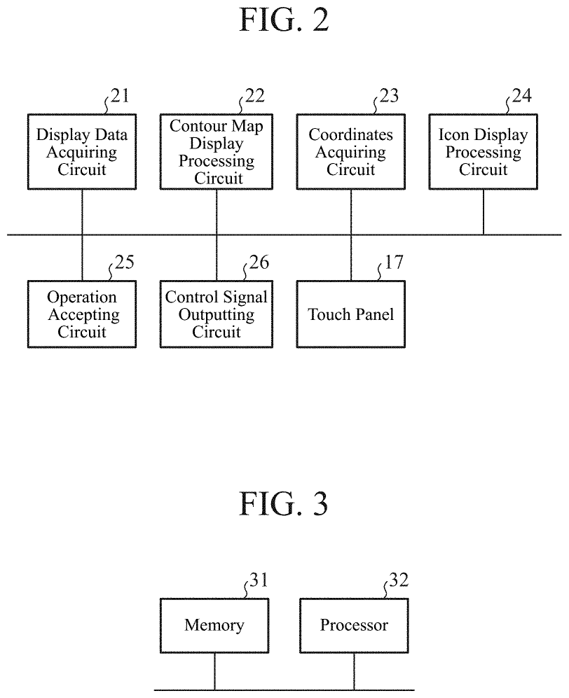

FIG. 2 is a hardware configuration diagram illustrating the hardware of the temperature setting device 5 according to the first embodiment.

The air conditioning system 1 includes N air conditioners 2, a control device 3, a network 4, and the temperature setting device 5. N represents an integer greater than or equal to 1.

The air conditioner 2 is, for example, an air conditioner or a floor heater and is installed in a room.

Temperature sensors (not illustrated) for measuring the temperature are installed at a plurality of points in the room where the air conditioner 2 is installed.

The control device 3 acquires measurement values of the temperature from each of the plurality of temperature sensors (not illustrated) and generates display data of a contour map representing a temperature distribution of the room in which the air conditioner 2 is installed on the basis of the measurement values. The contour map representing the temperature distribution of the room represents a temperature distribution of a two-dimensional plane at a height of 1 m from the floor, a height of 1.5 m from the floor, or the like. Since the process itself of generating the display data of the contour map on the basis of the measurement values of the temperature is known technology, detailed description thereof will be omitted.

The control device 3 outputs the display data of the contour map to the temperature setting device 5 via the network 4.

The control device 3 controls each of the N air conditioners 2 in accordance with a first control signal, which will be described later, output from the temperature setting device 5 or a second control signal, which will be described later, output from the temperature setting device 5, thereby controlling the temperature at a desired point, which will be described later, in the room where the N air conditioners 2 are installed.

The air conditioning system 1 illustrated in FIG. 1 includes the control device 3 separately from the N air conditioners 2. However, this is merely an example, and each of the N air conditioners 2 may include the control device 3.

The network 4 is a communication network such as the Internet or a wireless local area network (LAN).

The temperature setting device 5 outputs the first control signal giving an instruction to lower the set temperature at a desired point or the second control signal giving an instruction to raise the set temperature at a desired point to the control device 3 via the network 4.

The temperature setting device 5 is mounted on, for example, any of a controller of an embedded device, a smartphone, a tablet computer, or a personal computer.

The temperature setting device 5 includes a display data acquiring unit 11, a contour map display processing unit 12, a coordinates acquiring unit 13, an icon display processing unit 14, an operation accepting unit 15, a control signal outputting unit 16, and a touch panel 17.

The temperature setting device 5 illustrated in FIG. 1 includes the touch panel 17. However, this is merely an example, and the touch panel 17 may be provided externally to the temperature setting device 5.

The display data acquiring unit 11 is implemented by, for example, a display data acquiring circuit 21 illustrated in FIG. 2.

The display data acquiring unit 11 is connected with the control device 3 via the network 4.

The display data acquiring unit 11 acquires the display data of the contour map output from the control device 3 and outputs the display data to the contour map display processing unit 12.

The contour map display processing unit 12 is implemented by, for example, a contour map display processing circuit 22 illustrated in FIG. 2.

The contour map display processing unit 12 displays the contour map on a screen of the touch panel 17 in accordance with the display data of the contour map output from the display data acquiring unit 11. The screen of the touch panel 17 is a screen of a display included in the touch panel 17 as will be described later.

The coordinates acquiring unit 13 is implemented by, for example, a coordinates acquiring circuit 23 illustrated in FIG. 2.

When contact with the contour map displayed on the screen of the touch panel 17 is detected, the coordinates acquiring unit 13 acquires position coordinates indicating the contact position with the contour map as position coordinates indicating a point at which the set temperature is to be changed. That is, the coordinates acquiring unit 13 acquires the position coordinates output from the touch panel 17 as position coordinates indicating a point at which the set temperature is to be changed.

Hereinafter, a point at which the set temperature is to be changed may be referred to as a desired point. The position coordinates output from the touch panel 17 indicate a contact position of a user's finger or the like with respect to the contour map.

The coordinates acquiring unit 13 outputs the position coordinates indicating the desired point to each of the icon display processing unit 14 and the control signal outputting unit 16.

The icon display processing unit 14 is implemented by, for example, an icon display processing circuit 24 illustrated in FIG. 2.

The icon display processing unit 14 displays a temperature changing point icon for representing the desired point to be superimposed on the contour map displayed on the screen of the touch panel 17.

The icon display processing unit 14 displays a first operation icon for accepting an operation of lowering a set temperature at the desired point to be superimposed on the contour map.

The icon display processing unit 14 displays a second operation icon for accepting an operation of raising a set temperature at the desired point to be superimposed on the contour map.

The operation accepting unit 15 is implemented by, for example, an operation accepting circuit 25 illustrated in FIG. 2.

When contact with a display area of the first operation icon on the screen of the touch panel 17 is detected, the operation accepting unit 15 performs processing of accepting an operation of lowering the set temperature. That is, when first operation information indicating that a user has touched the display area of the first operation icon is received from the touch panel 17, the operation accepting unit 15 performs processing of accepting an operation of lowering the set temperature.

When contact with a display area of the second operation icon on the screen of the touch panel 17 is detected, the operation accepting unit 15 performs processing of accepting an operation of raising the set temperature. That is, when second operation information indicating that a user has touched the display area of the second operation icon is received from the touch panel 17, the operation accepting unit 15 performs processing of accepting an operation of raising the set temperature.

Note that accepting an operation of lowering the set temperature means that the temperature setting device 5 accepts the operation to lower the set temperature when the touch panel 17 detects that a user has touched the display area of the first operation icon.

Note that accepting an operation of raising the set temperature means that the temperature setting device 5 accepts the operation to raise the set temperature when the touch panel 17 detects that a user has touched the display area of the second operation icon.

The control signal outputting unit 16 is implemented by, for example, a control signal outputting circuit 26 illustrated in FIG. 2.

The control signal outputting unit 16 is connected with the control device 3 via the network 4.

The control signal outputting unit 16 outputs, to the control device 3, the first control signal giving an instruction to lower the set temperature at the desired point, or the second control signal giving an instruction to raise the set temperature at the desired point, the desired point being the point indicated by the position coordinates acquired by the coordinates acquiring unit 13.

That is, when the operation of lowering the set temperature is accepted by the operation accepting unit 15, the control signal outputting unit 16 outputs the first control signal giving an instruction to lower the set temperature at the desired point to the control device 3 via the network 4.

When the operation of raising the set temperature is accepted by the operation accepting unit 15, the control signal outputting unit 16 outputs the second control signal giving an instruction to raise the set temperature at the desired point to the control device 3 via the network 4.

The touch panel 17 includes a display having a screen and a touch sensor provided to the screen.

The touch panel 17 displays each of the contour map, the temperature changing point icon, the first operation icon, and the second operation icon on the screen.

After the contour map is displayed on the screen, the touch panel 17 performs contact detection processing of a user's finger or the like with respect to the contour map.

When contact of a user's finger or the like is detected, the touch panel 17 outputs position coordinates indicating the contact position of the finger or the like to the coordinates acquiring unit 13.

After displaying each of the first operation icon and the second operation icon on the screen, the touch panel 17 performs the contact detection processing of a user's finger or the like with respect to each of the display area of the first operation icon and the display area of the second operation icon.

When contact with the display area of the first operation icon is detected, the touch panel 17 outputs first operation information indicating that a user has touched the display area of the first operation icon to the operation accepting unit 15.

When contact with the display area of the second operation icon is detected, the touch panel 17 outputs second operation information indicating that a user has touched the display area of the second operation icon to the operation accepting unit 15.

In the air conditioning system 1 illustrated in FIG. 1, the temperature setting device 5 includes the touch panel 17. However, this is merely an example, and the temperature setting device 5 may include a display and an input interface unit such as a keyboard or a mouse instead of the touch panel 17. The display displays each of the contour map, the temperature changing point icon, the first operation icon, and the second operation icon. When position coordinates indicating a desired point among the position coordinates in the contour map are input, the input interface unit outputs the position coordinates indicating the desired point to each of the coordinates acquiring unit 13 and the icon display processing unit 14. In addition, the input interface unit outputs either the first operation information or the second operation information to the operation accepting unit 15.

In FIG. 1, it is assumed that each of the display data acquiring unit 11, the contour map display processing unit 12, the coordinates acquiring unit 13, the icon display processing unit 14, the operation accepting unit 15, and the control signal outputting unit 16, which are some of the components of the temperature setting device 5, is implemented by dedicated hardware as illustrated in FIG. 2. That is, it is assumed that a part of the temperature setting device 5 is implemented by the display data acquiring circuit 21, the contour map display processing circuit 22, the coordinates acquiring circuit 23, the icon display processing circuit 24, the operation accepting circuit 25, and the control signal outputting circuit 26.

Each of the display data acquiring circuit 21, the contour map display processing circuit 22, the coordinates acquiring circuit 23, the icon display processing circuit 24, the operation accepting circuit 25, and the control signal outputting circuit 26 corresponds to a single circuit, a composite circuit, a programmed processor, a parallel-programmed processor, an application specific integrated circuit (ASIC), a field-programmable gate array (FPGA), or a combination thereof.

Some of the components of the temperature setting device 5 are not limited to those implemented by dedicated hardware, and a part of the temperature setting device 5 may be implemented by software, firmware, or a combination of software and firmware.

The software or the firmware is stored in a memory of a computer as a program. Here, a computer refers to hardware for executing the program and corresponds to, for example, a central processing unit (CPU), a central processing device, a processing device, an arithmetic device, a microprocessor, a microcomputer, a processor, or a digital signal processor (DSP).

FIG. 3 is a hardware configuration diagram of a computer in a case where a part of the temperature setting device 5 is implemented by software, firmware, or the like.

In a case where a part of the temperature setting device 5 is implemented by software, firmware, or the like, a temperature setting program, which is a program for causing a computer to execute each processing procedure performed in the display data acquiring unit 11, the contour map display processing unit 12, the coordinates acquiring unit 13, the icon display processing unit 14, the operation accepting unit 15, and the control signal outputting unit 16, is stored in a memory 31. Then, a processor 32 of the computer executes the temperature setting program stored in the memory 31.

In FIG. 2, an example in which each of some of the components of the temperature setting device 5 is implemented by dedicated hardware is shown, and in FIG. 3, an example in which a part of the temperature setting device 5 is implemented by software, firmware, or the like is shown. However, these are merely examples, and out of the some of the components of the temperature setting device 5, some of the components may be implemented by dedicated hardware, and the remaining components may be implemented by software, firmware, or the like.

Next, the operation of the air conditioning system 1 illustrated in FIG. 1 will be described.

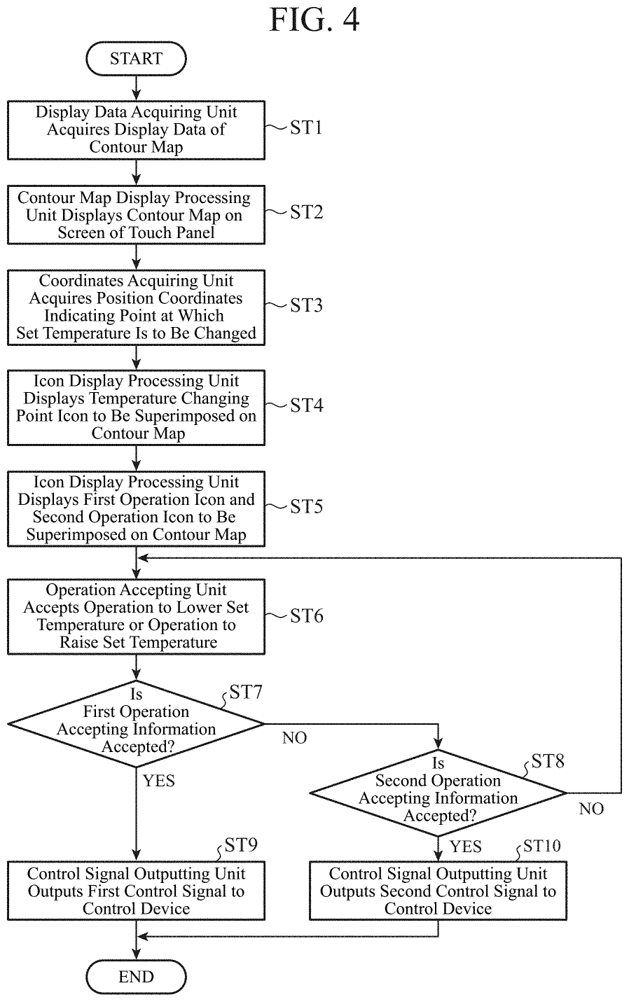

FIG. 4 is a flowchart illustrating a processing procedure performed in the temperature setting device 5.

The control device 3 acquires a measurement value of the temperature from each of a plurality of temperature sensors (not illustrated).

The control device 3 generates display data of the contour map representing the temperature distribution of the room in which the air conditioners 2 are installed on the basis of the measurement values that have been acquired.

The control device 3 outputs the display data of the contour map to the temperature setting device 5 via the network 4.

The display data acquiring unit 11 of the temperature setting device 5 acquires the display data of the contour map output from the control device 3 (step ST1 in FIG. 4).

The display data acquiring unit 11 outputs the display data of the contour map that has been acquired to the contour map display processing unit 12.

When the display data of the contour map is received from the display data acquiring unit 11, the contour map display processing unit 12 displays the contour map representing the temperature distribution of the room on the screen of the touch panel 17 in accordance with the display data (step ST2 in FIG. 4).

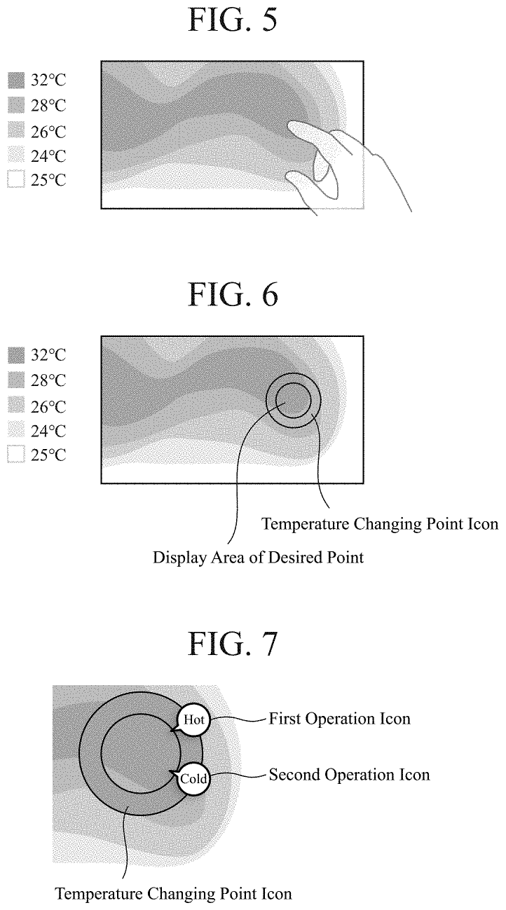

FIG. 5 is an explanatory diagram illustrating an example of the contour map displayed by the contour map display processing unit 12.

After displaying the contour map, the touch panel 17 performs the contact detection processing of a user's finger or the like with respect to the contour map.

When contact of a user's finger or the like is detected, the touch panel 17 outputs position coordinates indicating the contact position of the finger or the like to the coordinates acquiring unit 13.

The coordinates acquiring unit 13 acquires the position coordinates output from the touch panel 17 as position coordinates indicating a point at which the set temperature is to be changed (step ST3 in FIG. 4).

The coordinates acquiring unit 13 outputs the position coordinates indicating the desired point, which is a point at which the set temperature is to be changed, to each of the icon display processing unit 14 and the control signal outputting unit 16.

When the position coordinates indicating the desired point are received from the coordinates acquiring unit 13, the icon display processing unit 14 displays the temperature changing point icon indicating the desired point to be superimposed on the contour map displayed on the screen of the touch panel 17 as illustrated in FIG. 6 (step ST4 in FIG. 4).

FIG. 6 is an explanatory diagram illustrating an example of the temperature changing point icon displayed by the icon display processing unit 14.

In the temperature changing point icon illustrated in FIG. 6, among the display area of the temperature changing point icon, a display area of the desired point is transparent. That is, the temperature changing point icon illustrated in FIG. 6 is a frame-shaped icon in which the display area of the desired point is hollowed out in the display area of the temperature changing point icon.

In FIG. 6, an icon of a ring is displayed as the frame-shaped icon. Since the desired point of the temperature changing point icon is transparent, even though the icon display processing unit 14 displays the temperature changing point icon to be superimposed on the contour map, the contour map is visible through the display area of the desired point. In the temperature changing point icon illustrated in FIG. 6, the inside of the ring is the display area of the desired point.

In the temperature changing point icon illustrated in FIG. 6, the position coordinates of the center of the ring correspond to the position coordinates indicating the desired point.

In addition, as illustrated in FIG. 7, the icon display processing unit 14 displays the first operation icon for accepting the operation of lowering the set temperature at the desired point and the second operation icon for accepting the operation of raising the set temperature at the desired point to be superimposed on the contour map (step ST5 in FIG. 4).

FIG. 7 is an explanatory diagram illustrating an example of the first operation icon and an example of the second operation icon displayed by the icon display processing unit 14.

In the first operation icon illustrated in FIG. 7, a speech balloon illustration of letters “Hot” is used as an icon for accepting the operation of lowering the set temperature at the desired point.

In the second operation icon illustrated in FIG. 7, a speech balloon illustration of letters “Cold” is used as an icon for accepting the operation of raising the set temperature at the desired point.

In the example of FIG. 7, the icon display processing unit 14 displays each of the first operation icon and the second operation icon at positions overlapping the ring portion of the temperature changing point icon.

After displaying each of the first operation icon and the second operation icon, the touch panel 17 performs the contact detection processing of a user's linger or the like with respect to the display area of the first operation icon and the contact detection processing of a user's finger or the like with respect to the display area of the second operation icon.

When contact of a finger or the like with the display area of the first operation icon is detected, the touch panel 17 outputs, to the operation accepting unit 15, the first operation information indicating that a user has touched the display area of the first operation icon.

When contact of a finger or the like with the display area of the second operation icon is detected, the touch panel 17 outputs, to the operation accepting unit 15, the second operation information indicating that a user has touched the display area of the second operation icon.

When first operation information is received from the touch panel 17, the operation accepting unit 15 accepts an operation of lowering the set temperature (step ST6 in FIG. 4).

When the operation of lowering the set temperature is accepted, the operation accepting unit 15 outputs first operation accepting information indicating that the operation of lower the set temperature has been accepted to the control signal outputting unit 16.

When second operation information is received from the touch panel 17, the operation accepting unit 15 accepts an operation of raising the set temperature (step ST6 in FIG. 4).

When the operation of raising the set temperature is accepted, the operation accepting unit IS outputs second operation accepting information indicating that the operation of raising the set temperature has been accepted to the control signal outputting unit 16.

When the first operation accepting information is received from the operation accepting unit 15 (if YES in step ST7 in FIG. 4), the control signal outputting unit 16 outputs the first control signal giving an instruction to lower the set temperature of the desired point to the control device 3 via the network 4 (step ST9 in FIG. 4). The first control signal includes the position coordinates output from the coordinates acquiring unit 13.

When the second operation accepting information is received from the operation accepting unit 15 (if No in step ST7 in FIG. 4, if YES in step ST8 in FIG. 4), the control signal outputting unit 16 outputs the second control signal giving an instruction to raise the set temperature of the desired point to the control device 3 via the network 4 (step ST10 in FIG. 4). The second control signal includes the position coordinates output from the coordinates acquiring unit 13.

If neither the first operation accepting information nor the second operation accepting information is received from the operation accepting unit 15 (if NO in step ST7 in FIG. 4, if NO in step ST8 in FIG. 4), the control signal outputting unit 16 stands by until the first operation accepting information or the second operation accepting information is received.

When the first control signal is received from the temperature setting device 5, the control device 3 changes the setting to lower the set temperature at the desired point in the room where the N air conditioners 2 are installed in accordance with the first control signal.

When the second control signal is received from the temperature setting device 5, the control device 3 changes the setting to raise the set temperature at the desired point in the room where the N air conditioners 2 are installed in accordance with the second control signal.

An internal memory of the control device 3 stores the correspondence relationship between the position coordinates output from the coordinates acquiring unit 13 and each point in the room. In addition, the internal memory of the control device 3 stores a set temperature at each point in the room.

The control device 3 controls each of the N air conditioners 2 so that the temperature at the desired point in the room in which the N air conditioners 2 are installed matches the set temperature after changing the setting.

The process itself in which the control device 3 controls each of the N air conditioners 2 so that the temperature at the desired point matches the set temperature after changing the setting is known technology, and thus detailed description thereof will be omitted. As an example, the following control is conceivable.

The control device 3 controls each of the wind direction, the wind volume, and the wind temperature output from each of the N air conditioners 2 on the basis of the temperature at the desired point, the temperature around the desired point, and the set temperature at the desired point.

In the first embodiment described above, the temperature setting device 5 includes: the contour map display processing unit 12 to display a contour map representing a temperature distribution in a room where the air conditioners 2 are installed on a screen in accordance with display data of the contour map; the coordinates acquiring unit 13 to acquire, when contact with the contour map displayed on the screen is detected, position coordinates indicating a position of the contact on the contour map as position coordinates indicating a point at which the set temperature is to be changed; and the control signal outputting unit 16 to output, to the control device 3 of the air conditioners 2, the first control signal giving an instruction to lower the set temperature at the point or the second control signal giving an instruction to raise the set temperature at the point, the point being indicated by the position coordinates acquired by the coordinates acquiring unit 13.

Therefore, the temperature setting device 5 can set the temperature at a desired point in the room where the air conditioners 2 are installed.

In the temperature setting device 5 illustrated in FIG. 1, the temperature at a desired point in the room where the air conditioners 2 are installed is set. However, this is merely an example, and the temperature setting device 5 may set the humidity at a desired point in the room where the air conditioners 2 are installed in addition to setting the temperature at a desired point or may set the humidity at a desired point instead of the temperature at the desired point.

In a case where the temperature setting device 5 is a device that sets the humidity at a desired point in the room, the control device 3 outputs display data of a contour map representing a humidity distribution in the room in which the air conditioners 2 are installed to the temperature setting device 5.

The contour map display processing unit 12 displays the contour map on the screen of the touch panel 17 in accordance with the display data output from the control device 3.

When contact with the contour map displayed on the screen of the touch panel 17 is detected, the coordinates acquiring unit 13 acquires position coordinates indicating the contact position with the contour map as position coordinates indicating the point at which a set humidity is to be changed.

The icon display processing unit 14 displays, on the screen of the touch panel 17, a first operation icon for accepting an operation of lowering the set humidity at the point indicated by the position coordinates acquired by the coordinates acquiring unit 13 and a second operation icon for accepting an operation of raising the set humidity at the point.

When contact with a display area of the first operation icon on the screen of the touch panel 17 is detected, the operation accepting unit 15 accepts an operation of lowering the set humidity, and when contact with a display area of the second operation icon on the screen of the touch panel 17 is detected, the operation accepting unit 15 accepts an operation of raising the set humidity.

When the operation of lowering the set humidity is accepted by the operation accepting unit 15, the control signal outputting unit 16 outputs, instead of the first control signal, a third control signal giving an instruction to lower the set humidity at the point to the control device 3.

When the operation of raising the set humidity is accepted by the operation accepting unit IS, the control signal outputting unit 16 outputs, instead of the second control signal, a fourth control signal giving an instruction to raise the set humidity at the point to the control device 3.

When the third control signal is received from the temperature setting device 5, the control device 3 changes the setting to lower the set humidity at the desired point in the room where the N air conditioners 2 are installed in accordance with the third control signal.

When the fourth control signal is received from the temperature setting device 5, the control device 3 changes the setting to raise the set humidity at the desired point in the room where the N air conditioners 2 are installed in accordance with the fourth control signal.

The internal memory of the control device 3 stores a set humidity at each point in the room.

The control device 3 controls each of the N air conditioners 2 so that the humidity at the desired point in the room in which the N air conditioners 2 are installed matches the set humidity after changing the setting.

The process itself in which the control device 3 controls each of the N air conditioners 2 so that the humidity at a desired point matches the set humidity after changing the setting is known technology, and thus detailed description thereof will be omitted.

### Second Embodiment

In a second embodiment, a temperature setting device that displays a sensible temperature icon indicating a sensible temperature felt by a user will be described.

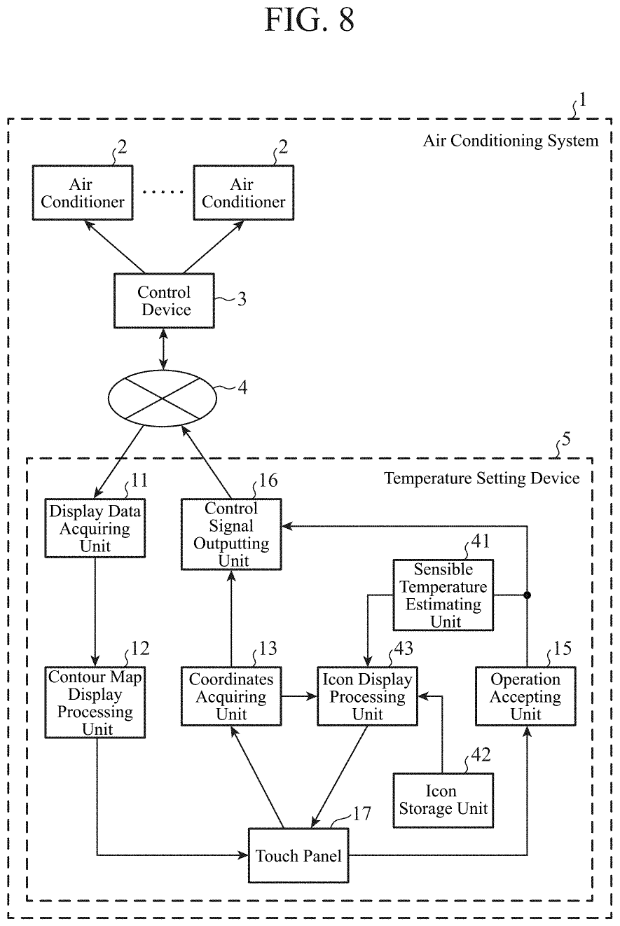

FIG. 8 is a configuration diagram illustrating an air conditioning system 1 including a temperature setting device 5 according to the second embodiment. In FIG. 8, the same symbols as those in FIG. 1 represent the same or corresponding parts, and thus description thereof is omitted.

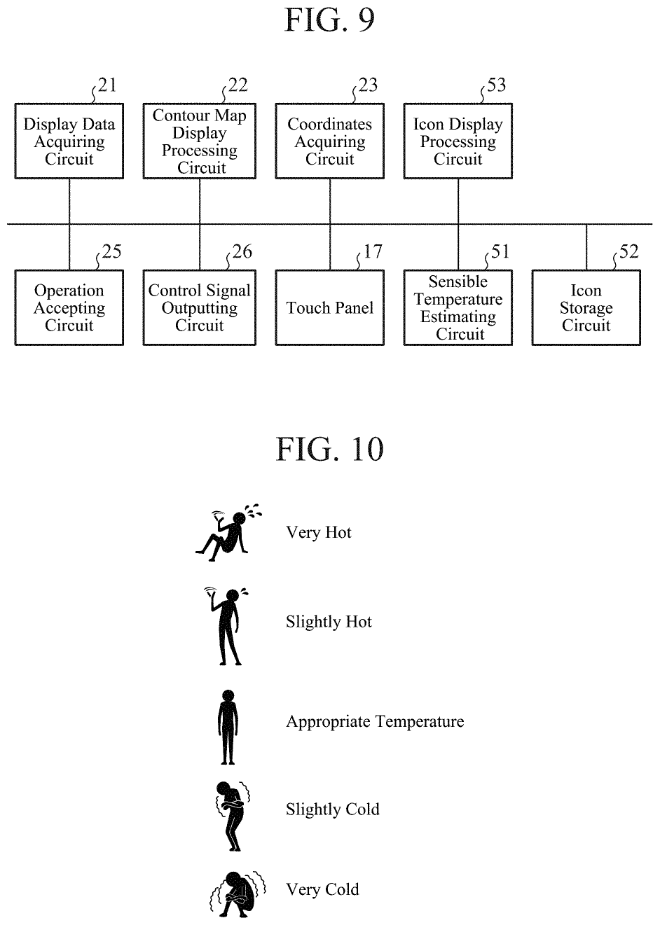

FIG. 9 is a hardware configuration diagram illustrating the hardware of the temperature setting device 5 according to the second embodiment. In FIG. 9, the same symbols as those in FIG. 2 represent the same or corresponding parts, and thus description thereof is omitted.

A sensible temperature estimating unit 41 is implemented by, for example, a sensible temperature estimating circuit 51 illustrated in FIG. 9.

The sensible temperature estimating unit 41 estimates a sensible temperature felt by a user on the basis of an operation of lowering the set temperature accepted by an operation accepting unit IS or an operation of raising the set temperature accepted by the operation accepting unit 15.

The sensible temperature estimating unit 41 outputs an estimation result of the sensible temperature to an icon display processing unit 43 which will be described later.

An icon storage unit 42 is implemented by, for example, an icon storage circuit 52 illustrated in FIG. 9.

The icon storage unit 42 stores graphic data of a plurality of sensible temperature icons.

The icon display processing unit 43 is implemented by, for example, an icon display processing circuit 53 illustrated in FIG. 9.

Similarly to the icon display processing unit 14 illustrated in FIG. 1, the icon display processing unit 43 displays each of the temperature changing point icon, the first operation icon, and the second operation icon to be superimposed on a contour map displayed on a screen of a touch panel 17.

The icon display processing unit 43 acquires graphic data of a sensible temperature icon indicating the sensible temperature estimated by the sensible temperature estimating unit 41 from the plurality of pieces of graphic data stored in the icon storage unit 42.

In accordance with the graphic data that has been acquired, the icon display processing unit 43 displays the sensible temperature icon in a display area of a desired point indicated by position coordinates acquired by a coordinates acquiring unit 13.

In FIG. 8, it is assumed that each of a display data acquiring unit 11, a contour map display processing unit 12, the coordinates acquiring unit 13, the operation accepting unit 15, a control signal outputting unit 16, the sensible temperature estimating unit 41, the icon storage unit 42, and the icon display processing unit 43, which are some of the components of the temperature setting device 5, is implemented by dedicated hardware as illustrated in FIG. 9. That is, it is assumed that a part of the temperature setting device 5 is implemented by a display data acquiring circuit 21, a contour map display processing circuit 22, a coordinates acquiring circuit 23, an operation accepting circuit 25, a control signal outputting circuit 26, the sensible temperature estimating circuit 51, the icon storage circuit 52, and the icon display processing circuit 53.

Here, the icon storage circuit 52 corresponds to a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disc, a flexible disc, an optical disc, a compact disc, a mini disc, or a digital versatile disc (DVD).

Each of the display data acquiring circuit 21, the contour map display processing circuit 22, the coordinates acquiring circuit 23, the operation accepting circuit 25, the control signal outputting circuit 26, the sensible temperature estimating circuit 51, and the icon display processing circuit 53 corresponds to, for example, a single circuit, a composite circuit, a programmed processor, a parallel programmed processor, an ASIC, an FPGA, or a combination thereof.

Some of the components of the temperature setting device 5 are not limited to those implemented by dedicated hardware, and a part of the temperature setting device 5 may be implemented by software, firmware, or a combination of software and firmware.

In a case where a part of the temperature setting device 5 is implemented by software, firmware, or the like, the icon storage unit 42 is configured on the memory 31 of the computer illustrated in FIG. 3. A temperature setting program, which is a program for causing a computer to execute each processing procedure performed in the display data acquiring unit 11, the contour map display processing unit 12, the coordinates acquiring unit 13, the operation accepting unit 15, the control signal outputting unit 16, the sensible temperature estimating unit 41, and the icon display processing unit 43, is stored in the memory 31. Then, the processor 32 of the computer executes the temperature setting program stored in the memory 31.

In FIG. 9, an example in which each of some of the components of the temperature setting device 5 is implemented by dedicated hardware is shown, and in FIG. 3, an example in which a part of the temperature setting device 5 is implemented by software, firmware, or the like is shown. However, this is merely an example, and out of the some of the components of the temperature setting device 5, some of the components may be implemented by dedicated hardware, and the remaining components may be implemented by software, firmware, or the like.

Next, the operation of the air conditioning system 1 illustrated in FIG. 8 will be described.

Note that, since components other than the sensible temperature estimating unit 41, the icon storage unit 42, and the icon display processing unit 43 are similar to those of the air conditioning system 1 illustrated in FIG. 1, the operation of the sensible temperature estimating unit 41, the icon storage unit 42, and the icon display processing unit 43 will be mainly described here.

The icon storage unit 42 stores graphic data of sensible temperature icons as illustrated in FIG. 10.

FIG. 10 is an explanatory diagram illustrating an example of the sensible temperature icons indicated by the graphic data stored in the icon storage unit 42.

In FIG. 10, a sensible temperature icon indicating that the sensible temperature felt by a user is “appropriate temperature”, a sensible temperature icon indicating that the sensible temperature is “slightly hot”, a sensible temperature icon indicating that the sensible temperature is “very hot”, a sensible temperature icon indicating that the sensible temperature is “slightly cold”, and a sensible temperature icon indicating that the sensible temperature is “very cold” are illustrated.

First, the icon display processing unit 43 acquires graphic data of the sensible temperature icon indicating that it is “appropriate temperature” from among the plurality of pieces of graphic data stored in the icon storage unit 42.

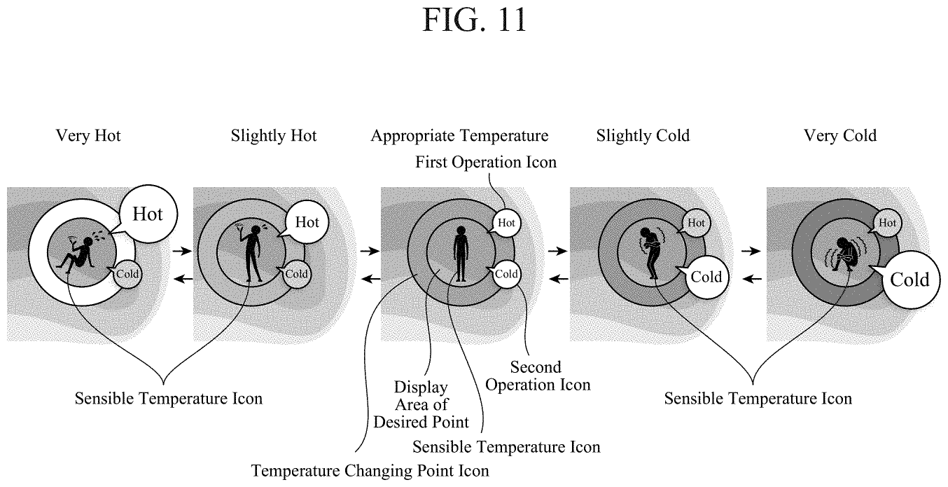

As illustrated in FIG. 11, the icon display processing unit 43 displays the sensible temperature icon indicating that it is “appropriate temperature” in the display area of the desired point in accordance with the graphic data that has been acquired.

FIG. 11 is an explanatory diagram illustrating a state in which a sensible temperature icon transitions by the operation by a user.

In the air conditioning system 1 illustrated in FIG. 8, when the user is feeling slightly hot, for example, the user touches the first operation icon once, and when the user is feeling very hot, for example, the user touches the first operation icon twice.

In addition, in the air conditioning system 1 illustrated in FIG. 8, when the user is feeling slightly cold, for example, the user touches the second operation icon once, and when the user is feeling very cold, for example, the user touches the second operation icon twice.

When the user touches the first operation icon once when the user is feeling slightly hot, the touch panel 17 outputs one piece of first operation information to the operation accepting unit 15.

When the one piece of first operation information is received from the touch panel 17, the operation accepting unit 15 outputs first operation accepting information indicating that an operation of lowering a set temperature has been accepted to each of the control signal outputting unit 16 and the sensible temperature estimating unit 41 once.

When the user touches the first operation icon twice when the user is feeling very hot, the touch panel 17 outputs two pieces of first operation information to the operation accepting unit 15.

When the two pieces of first operation information are received from the touch panel 17, the operation accepting unit 15 outputs the first operation accepting information to each of the control signal outputting unit 16 and the sensible temperature estimating unit 41 twice.

When the user touches the second operation icon once when the user is feeling slightly cold, the touch panel 17 outputs one piece of second operation information to the operation accepting unit IS.

When the one piece of second operation information is received from the touch panel 17, the operation accepting unit 15 outputs second operation accepting information indicating that an operation of raising the set temperature has been accepted to each of the control signal outputting unit 16 and the sensible temperature estimating unit 41 once.

When the user touches the second operation icon twice when the user is feeling very cold, the touch panel 17 outputs two pieces of second operation information to the operation accepting unit 15.

When the two pieces of second operation information are received from the touch panel 17, the operation accepting unit 15 outputs the second operation accepting information to each of the control signal outputting unit 16 and the sensible temperature estimating unit 41 twice.

The sensible temperature estimating unit 41 estimates the sensible temperature felt by the user on the basis of the first operation accepting information output from the operation accepting unit 15 or the second operation accepting information output from the operation accepting unit 15.

Hereinafter, estimation processing of the sensible temperature by the sensible temperature estimating unit 41 will be specifically described.

When the first operation accepting information is received from the operation accepting unit 15 once, the sensible temperature estimating unit 41 estimates that, as the bodily sensation of the user, the user is “feeling slightly hot”.

When the first operation accepting information is received from the operation accepting unit 15 twice, the sensible temperature estimating unit 41 estimates that, as the bodily sensation of the user, the user is “feeling very hot”.

When the second operation accepting information is received from the operation accepting unit 15 once, the sensible temperature estimating unit 41 estimates that, as the bodily sensation of the user, the user is “feeling slightly cold”.

When the second operation accepting information is received from the operation accepting unit 15 twice, the sensible temperature estimating unit 41 estimates that, as the bodily sensation of the user, the user is “feeling very cold”.

The sensible temperature estimating unit 41 outputs an estimation result of the sensible temperature to the icon display processing unit 43.

When the estimation result of the sensible temperature is received from the sensible temperature estimating unit 41, the icon display processing unit 43 acquires graphic data of a sensible temperature icon indicating the sensible temperature estimated by the sensible temperature estimating unit 41 from among the plurality of pieces of graphic data stored in the icon storage unit 42.

If the sensible temperature estimated by the sensible temperature estimating unit 41 is, for example, “feeling slightly hot”, the icon display processing unit 43 acquires graphic data of the sensible temperature icon indicating that the sensible temperature is “slightly hot”.

The icon display processing unit 43 displays the sensible temperature icon in the display area of the desired point in accordance with the graphic data that has been acquired.

It is illustrated in FIG. 11 that, when the user touches the first operation icon once while the sensible temperature icon indicating that the sensible temperature is “appropriate temperature” is displayed, the sensible temperature icon that is displayed is changed to the sensible temperature icon indicating that the sensible temperature is “slightly hot”. It is also illustrated that, when the user touches the first operation icon twice, the sensible temperature icon that is displayed is changed to the sensible temperature icon indicating that the sensible temperature is “very hot”.

It is illustrated in FIG. 11 that, when the user touches the second operation icon once while the sensible temperature icon indicating that the sensible temperature is “appropriate temperature” is displayed, the sensible temperature icon that is displayed is changed to the sensible temperature icon indicating that the sensible temperature is “slightly cold”. It is also illustrated that, when the user touches the second operation icon twice, the sensible temperature icon that is displayed is changed to the sensible temperature icon indicating that the sensible temperature is “very cold”.

Further, when the user touches the first operation icon once while the sensible temperature icon indicating that the sensible temperature is “very cold” is displayed, the sensible temperature icon that is displayed is changed to the sensible temperature icon indicating that the sensible temperature is “slightly cold”. Moreover, when the user touches the first operation icon twice, the sensible temperature icon that is displayed is changed to the sensible temperature icon indicating that the sensible temperature is “appropriate temperature”.

Further, when the user touches the second operation icon once while the sensible temperature icon indicating that the sensible temperature is “very hot” is displayed, the sensible temperature icon that is displayed is changed to the sensible temperature icon indicating that the sensible temperature is “slightly hot”. Moreover, when the user touches the second operation icon twice, the sensible temperature icon that is displayed is changed to the sensible temperature icon indicating that the sensible temperature is “appropriate temperature”.

In the second embodiment described above, the temperature setting device 5 illustrated in FIG. 8 includes the sensible temperature estimating unit 41 to estimate a sensible temperature felt by a user on the basis of the operation of lowering the set temperature accepted by the operation accepting unit 15 or the operation of raising the set temperature accepted by the operation accepting unit 15, in which the icon display processing unit 43 displays a sensible temperature icon indicating the sensible temperature estimated by the sensible temperature estimating unit 41 in the display area on the point indicated by the position coordinates acquired by the coordinates acquiring unit 13. Therefore, similarly to the temperature setting device 5 illustrated in FIG. 1, the temperature setting device 5 illustrated in FIG. 8 can set the temperature at a desired point in the room where the air conditioners 2 are installed. In addition, the temperature setting device 5 can clearly show the sensible temperature felt by the user at the desired point visually.

In the temperature setting device 5 illustrated in FIG. 8, the icon display processing unit 43 displays a sensible temperature icon indicating the sensible temperature estimated by the sensible temperature estimating unit 41. The icon display processing unit 43 may further have a function of making a sound effect using, for example, a speaker (not illustrated). The speaker may be incorporated in the icon display processing unit 43 or may be provided outside the icon display processing unit 43.

Specifically, the icon display processing unit 43 uses the speaker to play a first sound effect indicating the sensible temperature estimated by the sensible temperature estimating unit 41. If the sensible temperature estimated by the sensible temperature estimating unit 41 is, for example, “feeling slightly hot”, the icon display processing unit 43 outputs, from the speaker, sound indicating that it is “slightly hot” as the first sound effect. Alternatively, if the sensible temperature estimated by the sensible temperature estimating unit 41 is, for example, “feeling very cold”, the icon display processing unit 43 outputs, from the speaker, sound indicating that it is “very cold” as the first sound effect.

In addition, the icon display processing unit 43 uses, for example, the speaker to play a second sound effect indicating whether the set temperature is lowered or raised when the operation is accepted by the operation accepting unit 15. If the operation accepted by the operation accepting unit 15 is to lower the set temperature, the icon display processing unit 43 outputs, from the speaker, sound indicating that the “set temperature is lowered” as the second sound effect. Alternatively, if the operation accepted by the operation accepting unit 15 is to raise the set temperature, the icon display processing unit 43 outputs, from the speaker, sound indicating that the “set temperature is raised” as the second sound effect.

### Third Embodiment

In a third embodiment, description will be given on a temperature setting device 5 in which an icon display processing unit 44 changes the color of the temperature changing point icon when an operation of lowering a set temperature is accepted by an operation accepting unit 15 or an operation of raising the set temperature is accepted by the operation accepting unit 15.

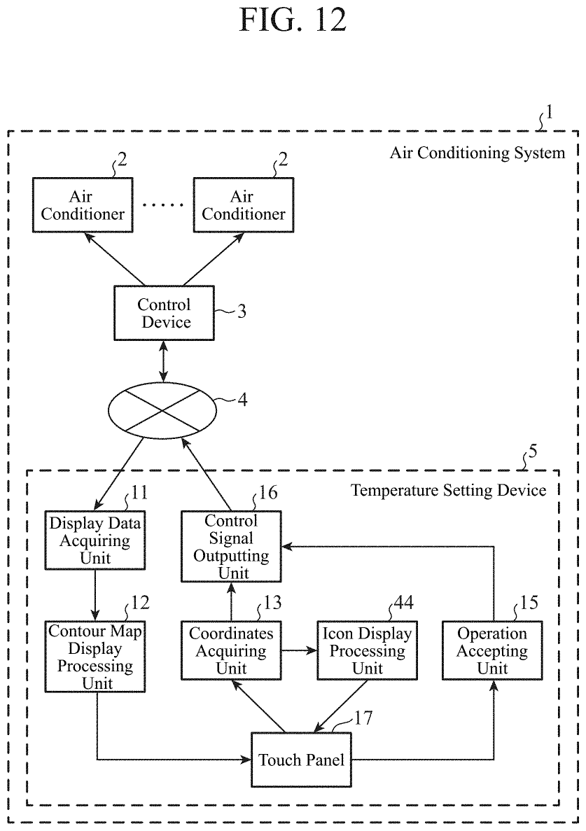

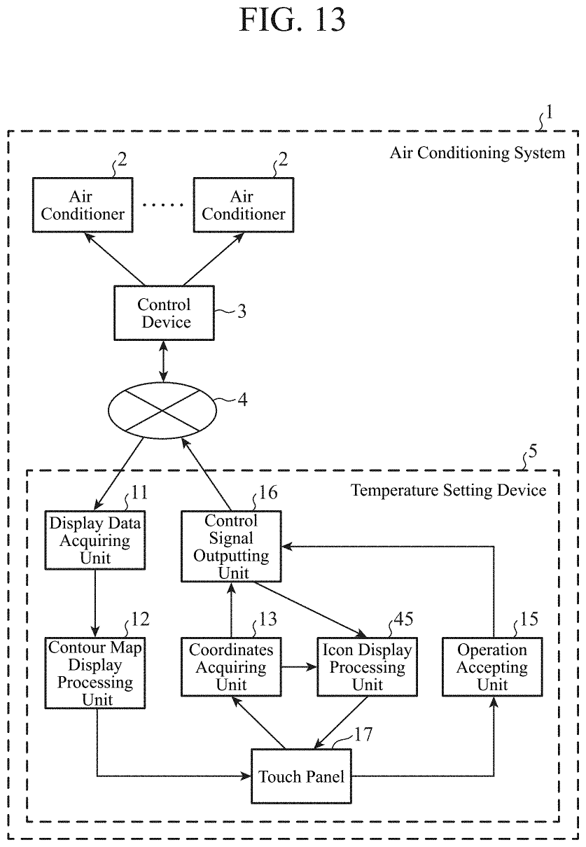

FIG. 12 is a configuration diagram illustrating an air conditioning system 1 including the temperature setting device 5 according to a third embodiment. In FIG. 12, the same symbols as those in FIG. 1 represent the same or corresponding parts, and thus description thereof is omitted.

The icon display processing unit 44 is implemented by, for example, the icon display processing circuit 24 illustrated in FIG. 2.

Similarly to the icon display processing unit 14 illustrated in FIG. 1, the icon display processing unit 44 displays the temperature changing point icon indicating a desired point, which is a point accepted by a coordinates acquiring unit 13, to be superimposed on a contour map displayed on a screen of a touch panel 17.

Similarly to the icon display processing unit 14 illustrated in FIG. 1, the icon display processing unit 44 displays each of the first operation icon and the second operation icon to be superimposed on the contour map.

The icon display processing unit 44 changes the color of the temperature changing point icon when an operation of lowering the set temperature is accepted by the operation accepting unit 15 or an operation of raising the set temperature is accepted by the operation accepting unit 15.

In the temperature setting device 5 illustrated in FIG. 12, the icon display processing unit 44 is applied to the temperature setting device 5 illustrated in FIG. 1. However, this is merely an example, and the icon display processing unit 44 may be applied to the temperature setting device 5 illustrated in FIG. 8.

Next, the operation of the air conditioning system 1 illustrated in FIG. 12 will be described.

Since components other than the icon display processing unit 44 are similar to those of the air conditioning system 1 illustrated in FIG. 1, the operation of the icon display processing unit 44 will be described here.

Similarly to the icon display processing unit 14 illustrated in FIG. 1, the icon display processing unit 44 displays the temperature changing point icon to be superimposed on the contour map displayed by the contour map display processing unit 12 and displays each of the first operation icon and the second operation icon to be superimposed on the contour map.

When an operation of lowering the set temperature is accepted once by the operation accepting unit 15 after the temperature changing point icon is displayed, the icon display processing unit 44 changes the color of a ring portion in the temperature changing point icon to, for example, light blue. When the operation of lowering the set temperature is accepted by the operation accepting unit 15 twice, the icon display processing unit 44 changes the color of the ring in the temperature changing point icon to, for example, blue.

When the operation of raising the set temperature is accepted once by the operation accepting unit 15 after the temperature changing point icon is displayed, the icon display processing unit 44 changes the color of the ring in the temperature changing point icon to, for example, orange. When the operation of raising the set temperature is accepted by the operation accepting unit 15 twice, the icon display processing unit 44 changes the color of the ring in the temperature changing point icon to, for example, red.

Here, the icon display processing unit 44 changes the color of the ring in the temperature changing point icon. However, this is merely an example, and the icon display processing unit 44 may change, for example, the color of the outline of the temperature changing point icon.

In the third embodiment described above, the temperature setting device 5 illustrated in FIG. 12 is configured so that the icon display processing unit 44 changes the color of the temperature changing point icon when an operation of lowering a set temperature is accepted by the operation accepting unit 15 or an operation of raising the set temperature is accepted by the operation accepting unit 15. Therefore, similarly to the temperature setting device 5 illustrated in FIG. 1, the temperature setting device 5 illustrated in FIG. 12 can set the temperature at a desired point in the room where the air conditioners 2 are installed and, in addition to that, can clearly indicate that the set temperature has been changed visually.

In the temperature setting device 5 illustrated in FIG. 12, the icon display processing unit 44 changes the color of the temperature changing point icon. The icon display processing unit 44 may further have a function of making a sound effect using, for example, a speaker (not illustrated). The speaker may be incorporated in the icon display processing unit 44 or may be provided outside the icon display processing unit 44.

Specifically, the icon display processing unit 44 uses the speaker to play a first sound effect indicating the sensible temperature felt by a user in accordance with the operation accepted by the operation accepting unit 15. If the operation accepted by the operation accepting unit 15 is to lower the set temperature, the icon display processing unit 44 outputs, from the speaker, sound indicating that it is “hot” as the first sound effect. Alternatively, if the operation accepted by the operation accepting unit 15 is to raise the set temperature, the icon display processing unit 44 outputs, from the speaker, sound indicating that it is “cold” as the first sound effect.

In addition, the icon display processing unit 44 uses, for example, the speaker to play a second sound effect indicating whether the set temperature is lowered or raised when the operation is accepted by the operation accepting unit 15. If the operation accepted by the operation accepting unit 15 is to lower the set temperature, the icon display processing unit 44 outputs, from the speaker, sound indicating that the “set temperature is lowered” as the second sound effect. Alternatively, if the operation accepted by the operation accepting unit 15 is to raise the set temperature, the icon display processing unit 44 outputs, from the speaker, sound indicating that the “set temperature is raised” as the second sound effect.

### Fourth Embodiment

In a fourth embodiment, description will be given on a temperature setting device 5 in which an icon display processing unit 45 displays an elapsed time icon indicating an elapsed time from output of either a first control signal or a second control signal from a control signal outputting unit 16.

FIG. 13 is a configuration diagram illustrating an air conditioning system 1 including the temperature setting device 5 according to the fourth embodiment. In FIG. 13, the same symbols as those in FIG. 1 represent the same or corresponding parts, and thus description thereof is omitted.

The icon display processing unit 45 is implemented by, for example, the icon display processing circuit 24 illustrated in FIG. 2.

Similarly to the icon display processing unit 14 illustrated in FIG. 1, the icon display processing unit 45 displays the temperature changing point icon indicating a desired point, which is a point accepted by a coordinates acquiring unit 13, to be superimposed on a contour map displayed on a screen of a touch panel 17.

Similarly to the icon display processing unit 14 illustrated in FIG. 1, the icon display processing unit 45 displays each of the first operation icon and the second operation icon to be superimposed on the contour map.

The icon display processing unit 45 displays an elapsed time icon indicating an elapsed time from output of either the first control signal or the second control signal by the control signal outputting unit 16 to be superimposed on the contour map.

In the temperature setting device 5 illustrated in FIG. 13, the icon display processing unit 45 is applied to the temperature setting device 5 illustrated in FIG. 1. However, this is merely an example, and the icon display processing unit 45 may be applied to the temperature setting device 5 illustrated in FIG. 8 or the temperature setting device 5 illustrated in FIG. 12.

Next, the operation of the air conditioning system 1 illustrated in FIG. 13 will be described.

Since components other than the icon display processing unit 45 are similar to those of the air conditioning system 1 illustrated in FIG. 1, the operation of the icon display processing unit 45 will be described here.

Similarly to the icon display processing unit 14 illustrated in FIG. 1, the icon display processing unit 45 displays the temperature changing point icon to be superimposed on the contour map displayed on the screen of the touch panel 17 and displays each of the first operation icon and the second operation icon to be superimposed on the contour map.

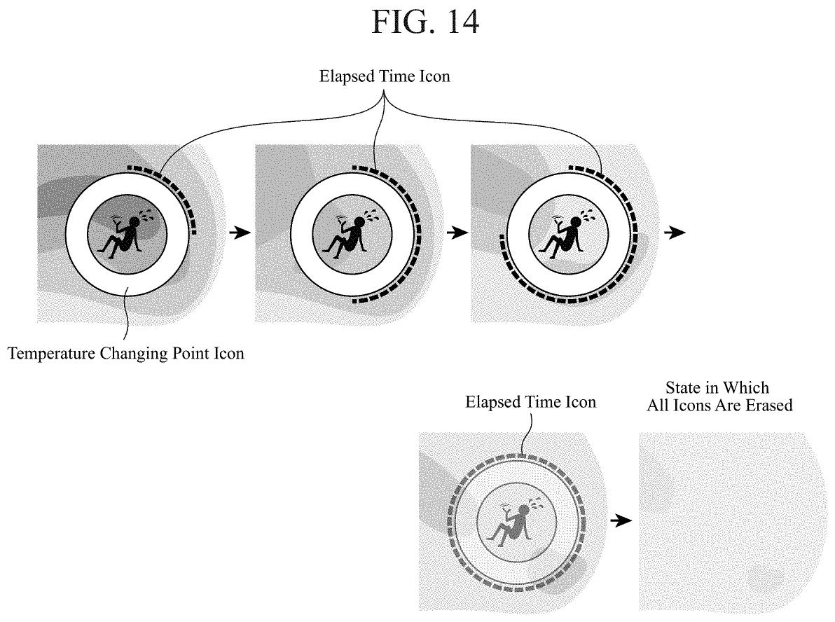

When the control signal outputting unit 16 outputs either the first control signal or the second control signal to a control device 3, the icon display processing unit 45 displays the elapsed time icon indicating an elapsed time from the output of either the first control signal or the second control signal to be superimposed on the contour map as illustrated in FIG. 14.

FIG. 14 is an explanatory diagram illustrating an example of the elapsed time icon displayed by the icon display processing unit 45.

In the example of FIG. 14, a broken line disposed around the temperature changing point icon is the elapsed time icon.

Each of the short lines forming the broken line indicates that, for example, one minute or two minutes have elapsed as the elapsed time. The elapsed time indicated by a short line can be set in the icon display processing unit 45 and may be stored in an internal memory of the icon display processing unit 45 or may be given externally to the icon display processing unit 45. In a case where the elapsed time indicated by a short line is set to, for example, one minute, if eight short lines are displayed, the elapsed time from output of either the first control signal or the second control signal is eight minutes.

After a predetermined period of time has elapsed from the output of either the first control signal or the second control signal by the control signal outputting unit 16, the icon display processing unit 45 erases each of the temperature changing point icon, the first operation icon, the second operation icon, and the elapsed time icon displayed on the screen of the touch panel 17 as illustrated in FIG. 14.

Such a predetermined period of time may be one hour, thirty minutes, or the like. The predetermined period of time may be stored in the internal memory of the icon display processing unit 45 or may be given externally to the icon display processing unit 45.

When a predetermined period of time elapses from the output of either the first control signal or the second control signal by the control signal outputting unit 16, it is presumed that the temperature at the desired point substantially reaches a set temperature.

In the fourth embodiment described above, the temperature setting device 5 illustrated in FIG. 13 is configured so that the icon display processing unit 45 displays the elapsed time icon indicating the elapsed time from output of either one of the first control signal or the second control signal by the control signal outputting unit 16 to be superimposed on the contour map. Therefore, similarly to the temperature setting device 5 illustrated in FIG. 1, the temperature setting device 5 illustrated in FIG. 13 can set the temperature at a desired point in the room where the air conditioners 2 are installed and, in addition to that, can clearly indicate the elapse of time after the set temperature has been changed visually.

### Fifth Embodiment

In a fifth embodiment, description will be given on a temperature setting device 5 in which, when an operation of changing a display area of the temperature changing point icon on a screen of a touch panel 17 is detected, a coordinates acquiring unit 61 changes position coordinates indicating a point at which a set temperature is to be changed in accordance with the operation of changing the display area.

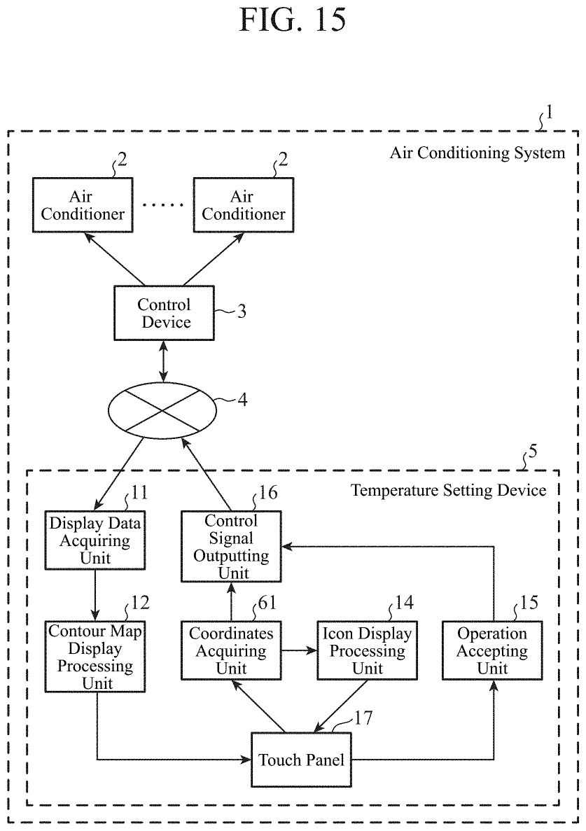

FIG. 15 is a configuration diagram illustrating an air conditioning system 1 including a temperature setting device 5 according to a fifth embodiment. In FIG. 15, the same symbols as those in FIG. 1 represent the same or corresponding parts, and thus description thereof is omitted.

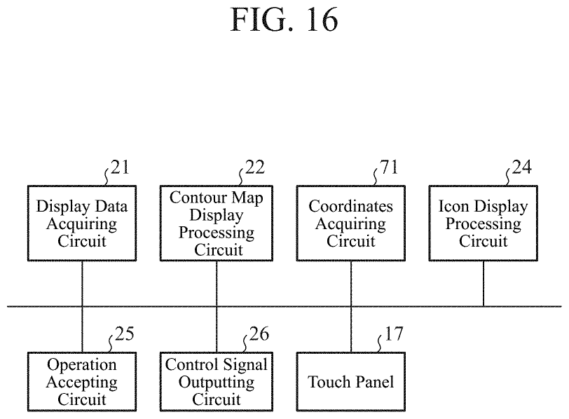

FIG. 16 is a hardware configuration diagram illustrating the hardware of the temperature setting device 5 according to the fifth embodiment. In FIG. 16, the same symbols as those in FIG. 2 represent the same or corresponding parts, and thus description thereof is omitted.

The coordinates acquiring unit 61 is implemented by, for example, a coordinates acquiring circuit 71 illustrated in FIG. 16.

Similarly to the coordinates acquiring unit 13 illustrated in FIG. 1, when contact with a contour map displayed on the screen of the touch panel 17 is detected, the coordinates acquiring unit 61 acquires position coordinates indicating the contact position with the contour map as position coordinates indicating the point at which a set temperature is to be changed.

Similarly to the coordinates acquiring unit 13 illustrated in FIG. 1, the coordinates acquiring unit 61 outputs the position coordinates indicating the point at which the set temperature is to be changed to each of an icon display processing unit 14 and a control signal outputting unit 16.

When an operation of changing a display area of the temperature changing point icon on the screen of the touch panel 17 is detected, the coordinates acquiring unit 61 changes position coordinates indicating a point at which the set temperature is to be changed in accordance with the operation of changing the display area. That is, when the touch panel 17 detects, for example, a drag operation by a user as the operation of changing the display area of the temperature changing point icon, the coordinates acquiring unit 61 changes the position coordinates indicating the point at which the set temperature is to be changed in accordance with the drag operation.

The coordinates acquiring unit 61 outputs the position coordinates before and after the change to the control signal outputting unit 16.

In the temperature setting device 5 illustrated in FIG. 15, the coordinates acquiring unit 61 is applied to the temperature setting device 5 illustrated in FIG. 1. However, this is merely an example, and the coordinates acquiring unit 61 may be applied to the temperature setting device 5 illustrated in FIG. 8, the temperature setting device 5 illustrated in FIG. 12, or the temperature setting device 5 illustrated in FIG. 13.

In FIG. 15, it is assumed that each of a display data acquiring unit 11, a contour map display processing unit 12, the icon display processing unit 14, an operation accepting unit 15, the control signal outputting unit 16, and the coordinates acquiring unit 61, which are some of the components of the temperature setting device 5, is implemented by dedicated hardware as illustrated in FIG. 16. That is, it is assumed that a part of the temperature setting device 5 is implemented by a display data acquiring circuit 21, a contour map display processing circuit 22, the icon display processing circuit 24, the operation accepting circuit 25, the control signal outputting circuit 26, and the coordinates acquiring circuit 71.

Each of the display data acquiring circuit 21, the contour map display processing circuit 22, the icon display processing circuit 24, the operation accepting circuit 25, the control signal outputting circuit 26, and the coordinates acquiring circuit 71 corresponds to, for example, a single circuit, a composite circuit, a programmed processor, a parallel programmed processor, an ASIC, an FPGA, or a combination thereof.

Some of the components of the temperature setting device 5 are not limited to those implemented by dedicated hardware, and a part of the temperature setting device 5 may be implemented by software, firmware, or a combination of software and firmware.

In a case where a part of the temperature setting device 5 is implemented by software, firmware, or the like, a temperature setting program, which is a program for causing a computer to execute each processing procedure performed in the display data acquiring unit 11, the contour map display processing unit 12, the icon display processing unit 14, the operation accepting unit 15, the control signal outputting unit 16, and the coordinates acquiring unit 61, is stored in the memory 31 illustrated in FIG. 3. Then, the processor 32 of the computer executes the temperature setting program stored in the memory 31.

Illustrated in FIG. 16 is an example in which each of some of the components of the temperature setting device 5 is implemented by dedicated hardware, whereas illustrated in FIG. 3 is an example in which a part of the temperature setting device 5 is implemented by software, firmware, or the like. However, this is merely an example, and out of the some of the components of the temperature setting device 5, some of the components may be implemented by dedicated hardware, and the remaining components may be implemented by software, firmware, or the like.

Next, the operation of the air conditioning system 1 illustrated in FIG. 15 will be described. Here, the operation of a portion different from that of the air conditioning system 1 illustrated in FIG. 1 will be described.

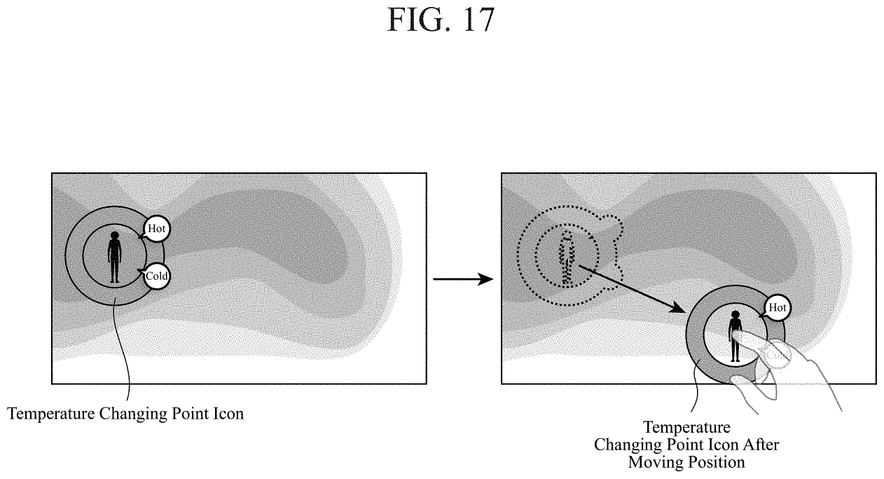

When a user performs a drag operation of moving the temperature changing point icon as illustrated in FIG. 17 after the temperature changing point icon, the first operation icon, and the second operation icon are each displayed, the touch panel 17 outputs information of the drag operation to each of the coordinates acquiring unit 61 and the icon display processing unit 14. The information of the drag operation here includes position information indicating position coordinates of the center position of the inner portion of the ring in the temperature changing point icon that has been moved.

FIG. 17 is an explanatory diagram illustrating a drag operation of moving the temperature changing point icon.

In FIG. 17, the drag operation of moving the temperature changing point icon is represented as an operation of dragging the inner portion of the ring in the temperature changing point icon.

When the information of the drag operation is received from the touch panel 17, the icon display processing unit 14 moves the temperature changing point icon that is displayed to the position after the moving that is indicated by the position information included in the information of the drag operation as illustrated in FIG. 17.

When the information of the drag operation is received from the touch panel 17, the coordinates acquiring unit 61 changes the position coordinates indicating the point at which the set temperature is to be changed to the position coordinates indicated by the position information included in the information of the drag operation.

The coordinates acquiring unit 61 outputs each of the position coordinates before the change and the position coordinates after the change to the control signal outputting unit 16.

When each of the position coordinates before the change and the position coordinates after the change is received from the coordinates acquiring unit 61, the control signal outputting unit 16 outputs a control signal including both of the position coordinates before the change and the position coordinates after the change to a control device 3 via a network 4.

When the control signal including both of the position coordinates before the change and the position coordinates after the change are received from the temperature setting device 5, the control device 3 changes a set temperature at a desired point indicated by the position coordinates after the change included in the control signal to the same temperature as the set temperature at a desired point indicated by the position coordinates before the change included in the control signal.

The control device 3 maintains the set temperature at the desired point before the change.

The control device 3 controls each of N air conditioners 2 so that the temperatures at the desired point before the change and the desired point after the change match the set temperature after the change of the setting.

In the fifth embodiment described above, the temperature setting device 5 illustrated in FIG. 15 is configured so that, when the operation of changing the display area of the temperature changing point icon on the screen is detected, the coordinates acquiring unit 61 changes position coordinates indicating a point at which a set temperature is to be changed in accordance with the operation of changing the display area. Therefore, similarly to the temperature setting device 5 illustrated in FIG. 1, the temperature setting device 5 illustrated in FIG. 15 can set the temperature at a desired point in the room where the air conditioners 2 are installed and, in addition to that, can set the temperature at a point different from the desired point to the same temperature as the temperature at the desired point.

### Sixth Embodiment

In a sixth embodiment, description will be given on a temperature setting device 5 in which an icon display processing unit 62 scales the temperature changing point icon displayed on a screen when an operation of scaling the temperature changing point icon is detected.

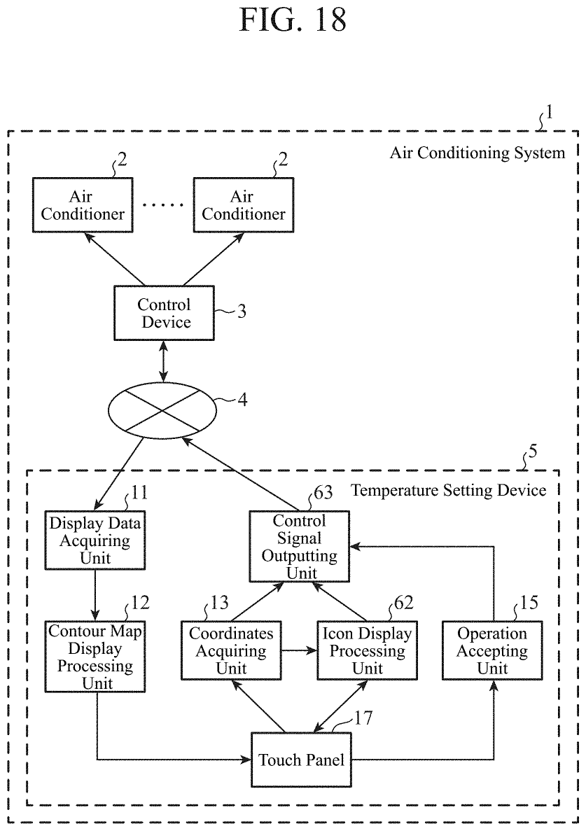

FIG. 18 is a configuration diagram illustrating an air conditioning system 1 including the temperature setting device 5 according to the sixth embodiment. In FIG. 18, the same symbols as those in FIG. 1 represent the same or corresponding parts, and thus description thereof is omitted.

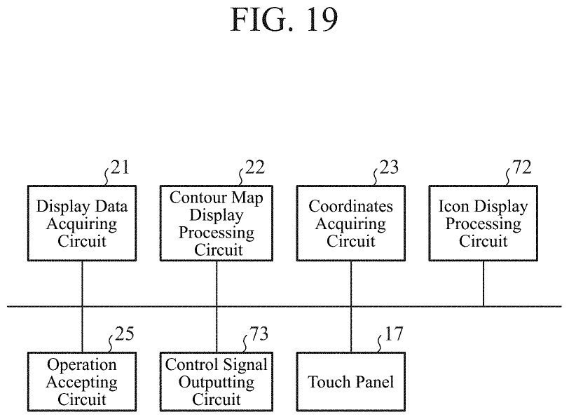

FIG. 19 is a hardware configuration diagram illustrating the hardware of the temperature setting device 5 according to the sixth embodiment. In FIG. 19, the same symbols as those in FIG. 2 represent the same or corresponding parts, and thus description thereof is omitted.

The icon display processing unit 62 is implemented by, for example, an icon display processing circuit 72 illustrated in FIG. 19.

Similarly to the icon display processing unit 14 illustrated in FIG. 1, the icon display processing unit 62 displays the temperature changing point icon representing a point indicated by position coordinates acquired by a coordinates acquiring unit 13 to be superimposed on the contour map displayed on a screen of a touch panel 17.

Similarly to the icon display processing unit 14 illustrated in FIG. 1, the icon display processing unit 62 displays each of the first operation icon and the second operation icon to be superimposed on the contour map.

When an operation of scaling the temperature changing point icon is detected, the icon display processing unit 62 scales the temperature changing point icon displayed on the screen of the touch panel 17. The scaling of the temperature changing point icon means either one of enlargement of the temperature changing point icon or reduction of the temperature changing point icon.

The icon display processing unit 62 outputs scaling information indicating the size of the temperature changing point icon after scaling to a control signal outputting unit 63 which will be described later.

The control signal outputting unit 63 is implemented by, for example, a control signal outputting circuit 73 illustrated in FIG. 19.

The control signal outputting unit 63 is connected with a control device 3 via a network 4.

Similarly to the control signal outputting unit 16 illustrated in FIG. 1, when an operation of lowering the set temperature is accepted by an operation accepting unit 15, the control signal outputting unit 63 outputs a first control signal giving an instruction to lower the set temperature at a desired point to the control device 3 via the network 4.

Similarly to the control signal outputting unit 16 illustrated in FIG. 1, when an operation of raising the set temperature is accepted by the operation accepting unit 15, the control signal outputting unit 63 outputs a second control signal giving an instruction to raise the set temperature at the desired point to the control device 3 via the network 4.

There are cases where the size of a display area on a point indicated by position coordinates acquired by the coordinates acquiring unit 13 is changed when the operation of scaling the temperature changing point icon is detected before either the operation of lowering the set temperature or the operation of raising the set temperature is accepted by the operation accepting unit 15. The display area on the point indicated by the position coordinates acquired by the coordinates acquiring unit 13 is in an area of the inner portion of the ring in the temperature changing point icon.

When the operation of lowering the set temperature is accepted by the operation accepting unit 15 after the scaling information has been received from the icon display processing unit 62, the control signal outputting unit 63 outputs a first control signal giving an instruction to lower the set temperature of the display area after changing the size to the control device 3 via the network 4.

When the operation of raising the set temperature is accepted by the operation accepting unit 15 after the scaling information has been received from the icon display processing unit 62, the control signal outputting unit 63 outputs a second control signal giving an instruction to raise the set temperature of the display area after changing the size to the control device 3 via the network 4.

In the temperature setting device 5 illustrated in FIG. 18, the icon display processing unit 62 and the control signal outputting unit 63 are both applied to the temperature setting device 5 illustrated in FIG. 1. However, this is merely an example, and the icon display processing unit 62 and the control signal outputting unit 63 may be both applied to the temperature setting device 5 illustrated in FIG. 8, the temperature setting device 5 illustrated in FIG. 12, the temperature setting device 5 illustrated in FIG. 13, or the temperature setting device 5 illustrated in FIG. 15.

In FIG. 18, it is assumed that each of a display data acquiring unit 11, a contour map display processing unit 12, the coordinates acquiring unit 13, the operation accepting unit 15, the icon display processing unit 62, and the control signal outputting unit 63, which are some of the components of the temperature setting device 5, is implemented by dedicated hardware as illustrated in FIG. 19. That is, it is assumed that a part of the temperature setting device 5 is implemented by a display data acquiring circuit 21, a contour map display processing circuit 22, a coordinates acquiring circuit 23, an operation accepting circuit 25, the icon display processing circuit 72, and the control signal outputting circuit 73.

Each of the display data acquiring circuit 21, the contour map display processing circuit 22, the coordinates acquiring circuit 23, the operation accepting circuit 25, the icon display processing circuit 72, and the control signal outputting circuit 73 corresponds to, for example, a single circuit, a composite circuit, a programmed processor, a parallel programmed processor, an ASIC, an FPGA, or a combination thereof.

Some of the components of the temperature setting device 5 are not limited to those implemented by dedicated hardware, and a part of the temperature setting device 5 may be implemented by software, firmware, or a combination of software and firmware.

In a case where a part of the temperature setting device 5 is implemented by software, firmware, or the like, a temperature setting program, which is a program for causing a computer to execute each processing procedure performed in the display data acquiring unit 11, the contour map display processing unit 12, the coordinates acquiring unit 13, the operation accepting unit 15, the icon display processing unit 62, and the control signal outputting unit 63, is stored in the memory 31 illustrated in FIG. 3. Then, the processor 32 of the computer executes the temperature setting program stored in the memory 31.

Illustrated in FIG. 19 is an example in which each of some of the components of the temperature setting device 5 is implemented by dedicated hardware, whereas illustrated in FIG. 3 is an example in which a part of the temperature setting device 5 is implemented by software, firmware, or the like. However, this is merely an example, and out of the some of the components of the temperature setting device 5, some of the components may be implemented by dedicated hardware, and the remaining components may be implemented by software, firmware, or the like.

Next, the operation of the air conditioning system 1 illustrated in FIG. 18 will be described. Here, the operation of a portion different from that of the air conditioning system 1 illustrated in FIG. 1 will be described.

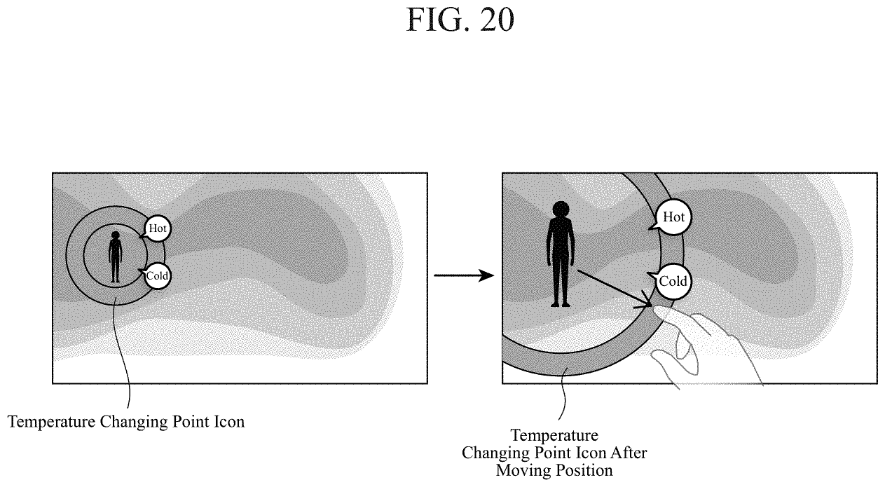

When a user performs a drag operation of scaling the temperature changing point icon as illustrated in FIG. 20 after the temperature changing point icon, the first operation icon, and the second operation icon are each displayed, the touch panel 17 outputs information of the drag operation to the icon display processing unit 62.

FIG. 20 is an explanatory diagram illustrating the drag operation of scaling the temperature changing point icon.

In FIG. 20, the operation of scaling the temperature changing point icon is represented as an operation of dragging the ring in the temperature changing point icon. The information of the drag operation here includes information indicating the radius moving distance of the ring in the temperature changing point icon.

In FIG. 20, the operation of scaling the temperature changing point icon is represented as an operation of dragging the ring in the temperature changing point icon. However, this is merely an example, and the operation of reducing the temperature changing point icon may be, for example, a pinch-in operation, and the operation of enlarging the temperature changing point icon may be, for example, a pinch-out operation.

When the information of the drag operation is received from the touch panel 17, the icon display processing unit 62 scales the temperature changing point icon that is displayed as illustrated in FIG. 20 on the basis of the information of the drag operation.

By scaling the temperature changing point icon that is currently displayed, the size of the display area on the point indicated by the position coordinates acquired by the coordinates acquiring unit 13, that is, the size of the area of the inner portion of the ring in the temperature changing point icon is changed.

The icon display processing unit 62 calculates the size of the temperature changing point icon after the scaling on the basis of the information of the drag operation.

The position of the center point of the area inside the ring in the temperature changing point icon and the radius of the inner circumference of the ring before the scaling are recognized in the icon display processing unit 62. For example, the icon display processing unit 62 calculates the size of the temperature changing point icon after the scaling from the position of the center point, the radius of the inner circumference of the ring before the scaling, and the radius moving distance of the ring indicated by the information of the drag operation.

The icon display processing unit 62 outputs the scaling information indicating the size of the temperature changing point icon after the scaling to the control signal outputting unit 63.

When the operation of lowering the set temperature is accepted by the operation accepting unit 15 after the scaling information has been received from the icon display processing unit 62, the control signal outputting unit 63 outputs the first control signal giving an instruction to lower the set temperature of the display area of the desired point indicated by the temperature changing point icon after the scaling to the control device 3 via the network 4. The first control signal includes the scaling information output from the icon display processing unit 62.

When the operation of raising the set temperature is accepted by the operation accepting unit 15 after the scaling information has been received from the icon display processing unit 62, the control signal outputting unit 63 outputs the second control signal giving an instruction to raise the set temperature of the display area of the desired point indicated by the temperature changing point icon after the scaling to the control device 3 via the network 4. The second control signal includes the scaling information output from the icon display processing unit 62.

In the temperature setting device 5 illustrated in FIG. 18, when the operation of lowering the set temperature is accepted by the operation accepting unit 15 or the operation of raising the set temperature is accepted by the operation accepting unit 15 after the scaling information has been received from the icon display processing unit 62, the control signal outputting unit 63 outputs the first control signal or the second control signal to the control device 3. However, this is merely an example, and the control signal outputting unit 63 may output the first control signal or the second control signal to the control device 3 when the scaling information is received from the icon display processing unit 62 after the operation of lowering the set temperature is accepted by the operation accepting unit 15 or the operation of raising the set temperature is accepted by the operation accepting unit 15.

When either the first control signal or the second control signal is received from the temperature setting device 5, the control device 3 recognizes the display area of the desired point indicated by the temperature changing point icon after the scaling from the scaling information included in the first control signal or the scaling information included in the second control signal.

When the first control signal is received from the temperature setting device 5, the control device 3 changes the setting to lower the set temperature of an area in a room corresponding to the display area of the desired point indicated by the temperature changing point icon after the scaling in accordance with the first control signal.

When the second control signal is received from the temperature setting device 5, the control device 3 changes the setting to raise the set temperature of an area in a room corresponding to the display area of the desired point indicated by the temperature changing point icon after the scaling in accordance with the second control signal.

An internal memory of the control device 3 stores the correspondence relationship between the position coordinates output from the coordinates acquiring unit 13 and a point in the room. The internal memory of the control device 3 stores also a set temperature at each point in the room.

The control device 3 controls each of N air conditioners 2 so that the temperature of the area in the room corresponding to the display area of the desired point indicated by the temperature changing point icon after the scaling matches the set temperature after changing the setting.

The process itself in which the control device 3 controls each of the N air conditioners 2 so that the temperature at the area in the room corresponding to the display area of the desired point matches the set temperature after changing the setting is known technology, and thus detailed description thereof will be omitted. As an example, the following control is conceivable.

The control device 3 controls each of the wind direction, the wind volume, and the wind temperature output from each of the N air conditioners 2 on the basis of the temperature at the area in the room, the temperature around the area in the room, and the set temperature at the area in the room.

In the sixth embodiment described above, the temperature setting device 5 illustrated in FIG. 18 is configured so that the icon display processing unit 62 scales the temperature changing point icon displayed on the screen when an operation of scaling the temperature changing point icon is detected. Therefore, similarly to the temperature setting device 5 illustrated in FIG. 1, the temperature setting device 5 illustrated in FIG. 18 can set the temperature at a desired point in the room where the air conditioners 2 are installed and, in addition to that, can change the area where the set temperature is to be changed.

### Seventh Embodiment

In the temperature setting devices 5 according to the first to sixth embodiments, the icon display processing units 14, 43, 44, 45, and 62 display the temperature changing point icon, the first operation icon, and the second operation icon as a set of icons.

In a seventh embodiment, description will be given on a temperature setting device 5 in which the icon display processing units 14, 43, 44, 45, and 62 display a plurality of sets of icons.

It is assumed that the configuration of the temperature setting device 5 according to the seventh embodiment is similar to the configuration of the temperature setting device 5 according to the first embodiment for convenience of description. Accordingly, the configuration diagram illustrating the temperature setting device 5 according to the seventh embodiment is FIG. 1. However, this is merely an example, and the configuration of the temperature setting device 5 according to the seventh embodiment may be similar to the configuration of the temperature setting device 5 according to any one of the second to sixth embodiments.

When the touch panel 17 detects contact with a user's finger or the like after displaying a contour map, position coordinates indicating the contact position with the finger or the like are output to the coordinates acquiring unit 13 similarly to the temperature setting device 5 according to the first embodiment.

In the temperature setting device 5 according to the seventh embodiment, when the touch panel 17 detects a plurality of contacts, position coordinates indicating a plurality of the contact positions are output to the coordinates acquiring unit 13.

The coordinates acquiring unit 13 acquires the plurality of position coordinates output from the touch panel 17 as position coordinates indicating a plurality of points where the set temperature is to be changed.

The coordinates acquiring unit 13 outputs the plurality of position coordinates to each of the icon display processing unit 14 and the control signal outputting unit 16.

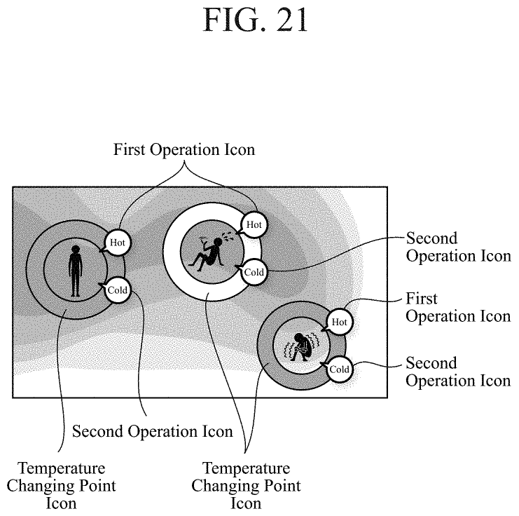

When the plurality of position coordinates is received from the coordinates acquiring unit 13, the icon display processing unit 14 displays the temperature changing point icons indicating desired points which are points indicated by the respective position coordinates to be superimposed on the contour map displayed on the screen of the touch panel 17 as illustrated in FIG. 21.

In addition, as illustrated in FIG. 21, the icon display processing unit 14 displays the first operation icon for accepting the operation of lowering a set temperature at each desired point and the second operation icon for accepting the operation of raising a set temperature at each desired point to be superimposed on the contour map.

FIG. 21 is an explanatory diagram illustrating a plurality of temperature changing point icons, a plurality of first operation icons, and a plurality of second operation icons displayed by the icon display processing unit 14.

In the example of FIG. 21, three temperature changing point icons, three first operation icons, and three second operation icons are displayed as three sets of icons.

After displaying the plurality of first operation icons and the plurality of second operation icons, the touch panel 17 performs contact detection processing with a user's finger or the like on each display area of the plurality of first operation icons.

The touch panel 17 also performs the contact detection processing with a user's finger or the like on each display area of the plurality of second operation icons.

When contact with a user's finger or the like on a display area of any one of the plurality of first operation icons is detected, the touch panel 17 outputs first operation information indicating the first operation icon touched by the user to the operation accepting unit 15. When contact with a user's finger or the like on the display areas of the plurality of first operation icons is detected, the touch panel 17 outputs the first operation information indicating each first operation icon touched by the user to the operation accepting unit 15.

When contact with a user's finger or the like on a display area of any one of the plurality of second operation icons is detected, the touch panel 17 outputs first operation information indicating the second operation icon touched by the user to the operation accepting unit 15. When contact with a user's finger or the like on the display areas of the plurality of second operation icons is detected, the touch panel 17 outputs second operation information indicating each second operation icon touched by the user to the operation accepting unit 15.

When the first operation information is received from the touch panel 17, the operation accepting unit 15 specifies the first operation icon touched by the user by referring to the first operation information.

The operation accepting unit 15 accepts an operation of lowering a set temperature at a desired point indicated by a temperature changing point icon related to the first operation icon that has been specified from among the plurality of temperature changing point icons.

When the operation of lowering the set temperature is accepted, the operation accepting unit 15 outputs first operation accepting information indicating that the operation of lower the set temperature has been accepted to the control signal outputting unit 16.

When the second operation information is received from the touch panel 17, the operation accepting unit 15 specifies the second operation icon touched by the user by referring to the second operation information.

The operation accepting unit 15 accepts an operation of raising a set temperature at a desired point indicated by a temperature changing point icon related to the second operation icon that has been specified from among the plurality of temperature changing point icons.

When the operation of raising the set temperature is accepted, the operation accepting unit 15 outputs second operation accepting information indicating that the operation of raising the set temperature has been accepted to the control signal outputting unit 16.

When the first operation accepting information is received from the operation accepting unit 15, the control signal outputting unit 16 outputs, to the control device 3 via the network 4, a first control signal giving an instruction to lower the set temperature at the desired point indicated by the temperature changing point icon related to the first operation icon specified by the operation accepting unit 15.

When the second operation accepting information is received from the operation accepting unit 15, the control signal outputting unit 16 outputs, to the control device 3 via the network 4, a second control signal giving an instruction to raise the set temperature at the desired point indicated by the temperature changing point icon related to the first operation icon specified by the operation accepting unit 15.

When the first control signal is received from the temperature setting device 5, the control device 3 changes the setting to lower the set temperature at the desired point indicated by the temperature changing point icon related to the first operation icon specified by the operation accepting unit 15 in accordance with the first control signal.

In a case where there is a plurality of first operation icons specified by the operation accepting unit 15, the setting is changed so as to lower a set temperature at a desired point indicated by the temperature changing point icon related to each of the first operation icons that have been specified.

When the second control signal is received from the temperature setting device 5, the control device 3 changes the setting to raise the set temperature at the desired point indicated by the temperature changing point icon related to the second operation icon specified by the operation accepting unit 15 in accordance with the second control signal.

In a case where there is a plurality of second operation icons specified by the operation accepting unit 15, the setting is changed so as to raise a set temperature at a desired point indicated by the temperature changing point icon related to each of the second operation icons that have been specified.

The control device 3 controls each of the N air conditioners 2 so that the temperature at a desired point in the room in which the N air conditioners 2 are installed matches the set temperature after changing the setting.

The control device 3 controls, for example, each of the wind direction, the wind volume, and the wind temperature output from each of the N air conditioners 2 on the basis of the temperature at a desired point, the temperature around the desired point, and the set temperature at the desired point.

In a case where there is a plurality of desired points where the set temperature has been changed, the control device 3 controls, for example, each of the wind direction, the wind volume, and the wind temperature output from each of the N air conditioners 2 on the basis of the temperature at the plurality of desired points, the temperature around the plurality of the desired points, and the set temperature at the plurality of desired points.

In the seventh embodiment described above, the temperature setting device 5 is configured so that, when each of a plurality of position coordinates is acquired by the coordinates acquiring unit 13, the icon display processing unit 14 displays the temperature changing point icon for indicating a point indicated by each of the position coordinates, the first operation icon for accepting the operation of lowering a set temperature at a point indicated by each of the position coordinates, and the second operation icon for accepting the operation of raising a set temperature at the point indicated by each of the position coordinates to be superimposed on the contour map. Therefore, the temperature setting device 5 can set the temperature at a plurality of desired points in the room where the air conditioners 2 are installed.

### Eighth Embodiment

In an eighth embodiment, description will be given on a temperature setting device 5 including a temperature control range displaying unit 64 that displays, to be superimposed on a contour map, a temperature control range in which the temperature can be brought close to a set temperature by an air conditioner 2.

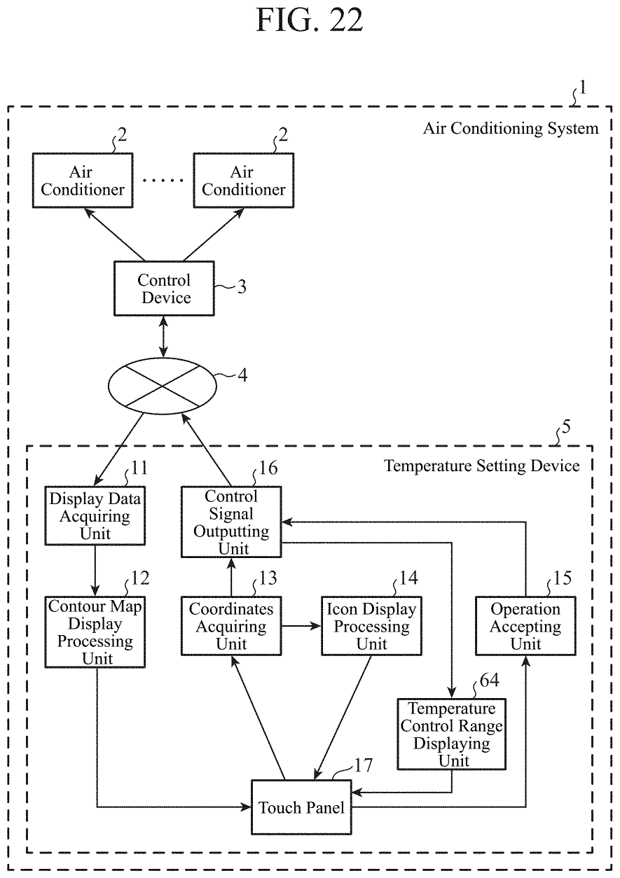

FIG. 22 is a configuration diagram illustrating an air conditioning system 1 including the temperature setting device 5 according to the eighth embodiment. In FIG. 22, the same symbols as those in FIG. 1 represent the same or corresponding parts, and thus description thereof is omitted.

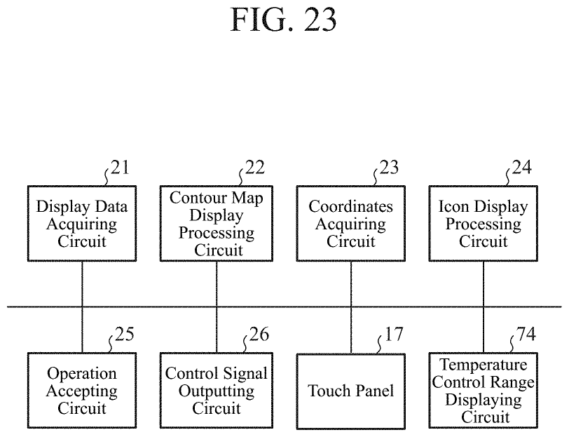

FIG. 23 is a hardware configuration diagram illustrating the hardware of the temperature setting device 5 according to the eighth embodiment. In FIG. 23, the same symbols as those in FIG. 2 represent the same or corresponding parts, and thus description thereof is omitted.

The temperature control range displaying unit 64 is implemented by, for example, a temperature control range displaying circuit 74 illustrated in FIG. 23.

When either a first control signal or a second control signal is output from a control signal outputting unit 16, the temperature control range displaying unit 64 displays, to be superimposed on a contour map, a temperature control range in which the temperature can be brought close to a set temperature by the air conditioner 2.

In the temperature setting device 5 illustrated in FIG. 22, the temperature control range displaying unit 64 is applied to the temperature setting device 5 illustrated in FIG. 1. However, this is merely an example, and the temperature control range displaying unit 64 may be applied to the temperature setting device 5 illustrated in FIG. 8, the temperature setting device 5 illustrated in FIG. 12, the temperature setting device 5 illustrated in FIG. 13, the temperature setting device 5 illustrated in FIG. 15, or the temperature setting device 5 illustrated in FIG. 18.

In FIG. 22, it is assumed that each of a display data acquiring unit 11, a contour map display processing unit 12, a coordinates acquiring unit 13, an icon display processing unit 14, an operation accepting unit 15, the control signal outputting unit 16, and the temperature control range displaying unit 64, which are some of the components of the temperature setting device 5, is implemented by dedicated hardware as illustrated in FIG. 23. That is, it is assumed that a part of the temperature setting device 5 is implemented by a display data acquiring circuit 21, a contour map display processing circuit 22, a coordinates acquiring circuit 23, an icon display processing circuit 24, an operation accepting circuit 25, a control signal outputting circuit 26, and the temperature control range displaying circuit 74.

Each of the display data acquiring circuit 21, the contour map display processing circuit 22, the coordinates acquiring circuit 23, the icon display processing circuit 24, the operation accepting circuit 25, the control signal outputting circuit 26, and the temperature control range displaying circuit 74 corresponds to, for example, a single circuit, a composite circuit, a programmed processor, a parallel programmed processor, an ASIC, an FPGA, or a combination thereof.

Some of the components of the temperature setting device 5 are not limited to those implemented by dedicated hardware, and a part of the temperature setting device 5 may be implemented by software, firmware, or a combination of software and firmware.

In a case where a part of the temperature setting device 5 is implemented by software, firmware, or the like, a temperature setting program, which is a program for causing a computer to execute each processing procedure performed in the display data acquiring unit 11, the contour map display processing unit 12, the coordinates acquiring unit 13, the icon display processing unit 14, the operation accepting unit 15, the control signal outputting unit 16, and the temperature control range displaying unit 64, is stored in the memory 31 illustrated in FIG. 3. Then, the processor 32 of the computer executes the temperature setting program stored in the memory 31.

Illustrated in FIG. 23 is an example in which each of some of the components of the temperature setting device 5 is implemented by dedicated hardware, whereas illustrated in FIG. 3 is an example in which a part of the temperature setting device 5 is implemented by software, firmware, or the like. However, this is merely an example, and out of the some of the components of the temperature setting device 5, some of the components may be implemented by dedicated hardware, and the remaining components may be implemented by software, firmware, or the like.

Next, the operation of the air conditioning system 1 illustrated in FIG. 22 will be described.

Since components other than the temperature control range displaying unit 64 are similar to those of the air conditioning system 1 illustrated in FIG. 1, the operation of only the temperature control range displaying unit 64 will be described here.

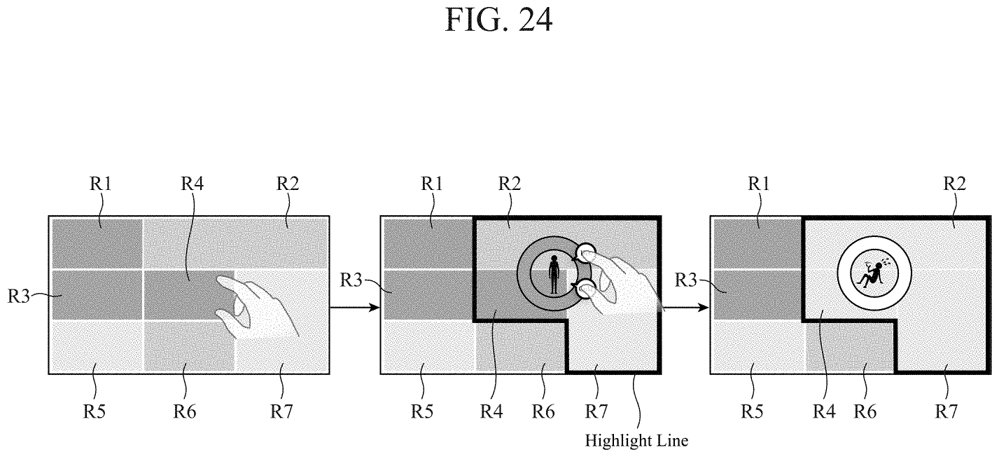

FIG. 24 is an explanatory diagram illustrating an example of the contour map displayed by the contour map display processing unit 12.

The contour map illustrated in FIG. 24 has a coarser temperature distribution in the room than the contour map illustrated in FIG. 5.

In the example of FIG. 24, the contour map is divided into seven rectangular regions R1 to R7, and the temperature changing point icon is displayed over three rectangular regions R2, R4, and R7 among the seven rectangular regions R1 to R7.

In the air conditioning system 1 illustrated in FIG. 22, for convenience of description, an area over which N air conditioners 2 can each control the temperature is a region, and each range in which the temperature can be controlled overlaps each of the regions R1 to R7 in the contour map.

Therefore, in the air conditioning system 1 illustrated in FIG. 22, when the temperature changing point icon displayed by the icon display processing unit 14 extends over, for example, the regions R2, R4, and R7, the temperature control range in which the temperature is brought close to a set temperature by the air conditioners 2 covers the regions R2, R4, and R7.

Alternatively, in a case where the temperature changing point icon displayed by the icon display processing unit 14 extends over, for example, the regions R1 and R3, the temperature control range in which the temperature is brought close to a set temperature by the air conditioners 2 covers the regions R1 and R3.

In a case where the temperature changing point icon displayed by the icon display processing unit 14 extends over, for example, the regions R2, R4, and R7, the temperature control range displaying unit 64 causes the icon display processing unit 14 to display a highlight line encircling the regions R2, R4, and R7 as illustrated in FIG. 24 so as to indicate a temperature control range in which the temperature is brought close to a set temperature.

In the eighth embodiment described above, the temperature setting device 5 illustrated in FIG. 22 includes the temperature control range displaying unit 64 that displays a temperature control range in which the temperature is brought close to a set temperature by air conditioners 2 to be superimposed on the contour map when either the first control signal or the second control signal is output by the control signal outputting unit 16. Therefore, similarly to the temperature setting device 5 illustrated in FIG. 1, the temperature setting device 5 illustrated in FIG. 22 can set the temperature at a desired point in the room where the air conditioners 2 are installed and, in addition to that, can visually clearly indicate a temperature control range in which the temperature is controlled by the air conditioners 2.

In the temperature setting devices 5 according to the first to eighth embodiments, the icon display processing units 14, 43, 44, 45, and 62 display the icon of a ring as the temperature changing point icon.

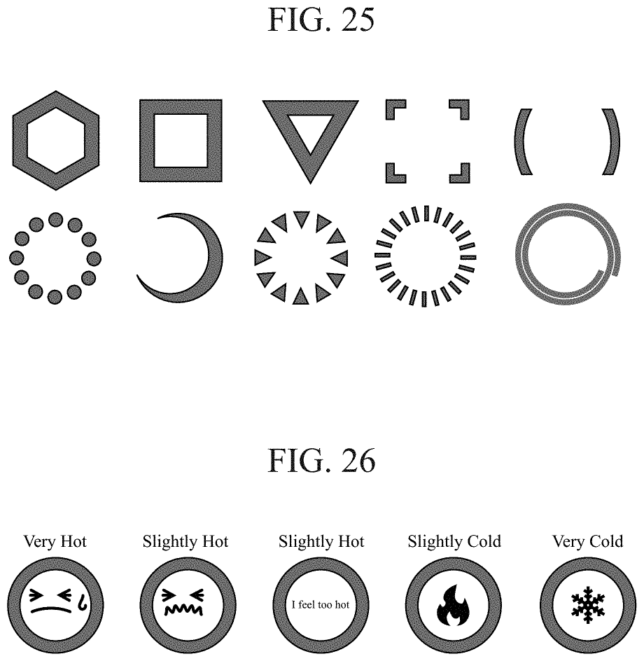

However, this is merely an example, and the icon display processing units 14, 43, 44, 45, and 62 may display icons having shapes as illustrated in FIG. 25 as the temperature changing point icon.

FIG. 25 is an explanatory diagram illustrating examples of the temperature changing point icon.

In the temperature setting devices 5 according to the second to eighth embodiments, the icon display processing units 43, 44, 45, and 62 display the sensible temperature icons as illustrated in FIG. 10 as the sensible temperature icon.

However, this is merely an example, and the icon display processing units 43, 44, 45, and 62 may display icons having shapes as illustrated in FIG. 26 as the sensible temperature icon.

FIG. 26 is an explanatory diagram illustrating an example of sensible temperature icons.

The sensible temperature icons illustrated in FIG. 26 are displayed inside the ring in the temperature changing point icon.

Note that the present disclosure may include a flexible combination of the embodiments, a modification of any component of the embodiments, or omission of any component in the embodiments.

### INDUSTRIAL APPLICABILITY

The present disclosure is suitable for a temperature setting device, a temperature setting method, and a storage medium storing temperature setting program for outputting a control signal to a control device of an air conditioner.

### REFERENCE SIGNS LIST

1: air conditioning system, 2: air conditioner, 3: control device, 4: network, 5: temperature setting device, 11: display data acquiring unit, 12: contour map display processing unit, 13: coordinates acquiring unit, 14: icon display processing unit, 15: operation accepting unit, 16: control signal outputting unit, 17: touch panel, 21: display data acquiring circuit, 22: contour map display processing circuit, 23: coordinates acquiring circuit, 24: icon display processing circuit, 25: operation accepting circuit, 26: control signal outputting circuit, 31: memory, 32: processor, 41: sensible temperature estimating unit, 42: icon storage unit, 43, 44, 45: icon display processing unit, 51: sensible temperature estimating circuit, 52: icon storage circuit, 53: icon display processing circuit, 61: coordinates acquiring unit, 62: icon display processing unit, 63: control signal outputting unit, 64: temperature control range displaying unit, 71: coordinates acquiring circuit, 72: icon display processing circuit, 73: control signal outputting circuit, 74: temperature control range displaying circuit

1. A temperature setting device comprising processing circuitry
to display a contour map representing a temperature distribution in a room where an air conditioner is installed on a screen in accordance with display data of the contour map,
to acquire, when contact with the contour map displayed on the screen is detected, position coordinates indicating a position of the contact on the contour map as position coordinates indicating a point in the room at which a set temperature is to be changed,
to perform output of, to a control device of the air conditioner, a first control signal giving an instruction to lower the set temperature at the point in the room or a second control signal giving an instruction to raise the set temperature at the point in the room, the point being indicated by the position coordinates,
to display, on the screen, a first operation icon for accepting an operation of lowering the set temperature at the point in the room and a second operation icon for accepting an operation of raising the set temperature at the point in the room, the point being indicated by the position coordinates,
to accept the operation of lowering the set temperature when contact with a display area of the first operation icon on the screen is detected and to accept the operation of raising the set temperature when contact with a display area of the second operation icon on the screen is detected, and
to estimate a sensible temperature felt by a user on a basis of the operation of lowering the set temperature or the operation of raising the set temperature,
wherein in the output, the processing circuitry outputs the first control signal to the control device when the operation of lowering the set temperature is accepted by the temperature setting device and outputs the second control signal to the control device when the operation of raising the set temperature is accepted by the temperature setting device, the processing circuitry displays a temperature changing point icon representing the point in the room indicated by the position coordinates to be superimposed on the contour map and displays each of the first operation icon and the second operation icon to be superimposed on the contour map, the processing circuitry displays, as the temperature changing point icon, an icon in which, in a display area of the temperature changing point icon, a display area on the point in the room indicated by the position coordinates is transparent to be superimposed on the contour map or a frame-shaped icon in which, in a display area of the temperature changing point icon, a display area on the point in the room indicated by the position coordinates is hollowed out to be superimposed on the contour map, and
the processing circuitry changes a color of the temperature changing point icon when the operation of lowering the set temperature is accepted by the temperature setting device or the operation of raising the set temperature is accepted by the temperature setting device,
wherein the processing circuitry displays a sensible temperature icon indicating the sensible temperature estimated in the display area on the point in the room indicated by the position coordinates.

2. The temperature setting device according to claim 1, wherein the processing circuitry plays a first sound effect indicating the sensible temperature estimated and, when an operation is accepted by the temperature setting device, plays a second sound effect indicating whether the set temperature is lowered or raised.

3. The temperature setting device according to claim 1, wherein the processing circuitry displays an elapsed time icon indicating an elapsed time from the output of either one of the first control signal or the second control signal to be superimposed on the contour map.

4. The temperature setting device according to claim 1, wherein, when an operation of changing a display area of the temperature changing point icon on the screen is detected, the processing circuitry changes the position coordinates indicating the point in the room at which the set temperature is to be changed in accordance with the operation of changing the display area.

5. The temperature setting device according to claim 1, wherein, when an operation of scaling the temperature changing point icon is detected, the processing circuitry scales the temperature changing point icon displayed on the screen.

6. The temperature setting device according to claim 1, wherein, when each of a plurality of position coordinates is acquired by the processing circuitry, the processing circuitry displays the temperature changing point icon for indicating the point in the room indicated by each of the position coordinates, the first operation icon for accepting the operation of lowering a set temperature at the point in the room indicated by each of the position coordinates, and the second operation icon for accepting the operation of raising a set temperature at the point in the room indicated by each of the position coordinates to be superimposed on the contour map.

7. A temperature setting method comprising:
displaying a contour map representing a temperature distribution in a room where an air conditioner is installed on a screen in accordance with display data of the contour map;
acquiring, when contact with the contour map displayed on the screen is detected, position coordinates indicating a position of the contact on the contour map as position coordinates indicating a point in the room at which a set temperature is to be changed;
outputting, to a control device of the air conditioner, a first control signal giving an instruction to lower the set temperature at the point in the room or a second control signal giving an instruction to raise the set temperature at the point in the room, the point being indicated by the position coordinates,
displaying, on the screen, a first operation icon for accepting an operation of lowering the set temperature at the point in the room and a second operation icon for accepting an operation of raising the set temperature at the point in the room, the point being indicated by the position coordinates, and
accepting the operation of lowering the set temperature when contact with a display area of the first operation icon on the screen is detected and accepting the operation of raising the set temperature when contact with a display area of the second operation icon on the screen is detected,
wherein in the output, processing circuitry outputs the first control signal to the control device when the operation of lowering the set temperature is accepted by the temperature setting device and outputs the second control signal to the control device when the operation of raising the set temperature is accepted by the temperature setting device,
the processing circuitry displays a temperature changing point icon representing the point in the room indicated by the position coordinates to be superimposed on the contour map and displays each of the first operation icon and the second operation icon to be superimposed on the contour map,
the processing circuitry displays, as the temperature changing point icon, an icon in which, in a display area of the temperature changing point icon, a display area on the point in the room indicated by the position coordinates is transparent to be superimposed on the contour map or a frame-shaped icon in which, in a display area of the temperature changing point icon, a display area on the point in the room indicated by the position coordinates is hollowed out to be superimposed on the contour map, and
the processing circuitry changes a color of the temperature changing point icon when the operation of lowering the set temperature is accepted by the temperature setting device or the operation of raising the set temperature is accepted by the temperature setting device,
wherein the processing circuitry displays a sensible temperature icon indicating the sensible temperature estimated in the display area on the point in the room indicated by the position coordinates.

8. A non-transitory computer-readable storage medium storing a program for causing a computer to execute processing comprising:
displaying a contour map representing a temperature distribution in a room where an air conditioner is installed on a screen in accordance with display data of the contour map;
acquiring, when contact with the contour map displayed on the screen is detected, position coordinates indicating a position of the contact on the contour map as position coordinates indicating a point in the room at which a set temperature is to be changed;
outputting, to a control device of the air conditioner, a first control signal giving an instruction to lower the set temperature at the point in the room or a second control signal giving an instruction to raise the set temperature at the point in the room, the point being indicated by the position coordinates;
displaying, on the screen, a first operation icon for accepting an operation of lowering the set temperature at the point in the room and a second operation icon for accepting an operation of raising the set temperature at the point in the room, the point being indicated by the position coordinates; and
accepting the operation of lowering the set temperature when contact with a display area of the first operation icon on the screen is detected and accepting the operation of raising the set temperature when contact with a display area of the second operation icon on the screen is detected,
wherein in the output, processing circuitry outputs the first control signal to the control device when the operation of lowering the set temperature is accepted by the temperature setting device and outputs the second control signal to the control device when the operation of raising the set temperature is accepted by the temperature setting device,
the processing circuitry displays a temperature changing point icon representing the point in the room indicated by the position coordinates to be superimposed on the contour map and displays each of the first operation icon and the second operation icon to be superimposed on the contour map,
the processing circuitry displays, as the temperature changing point icon, an icon in which, in a display area of the temperature changing point icon, a display area on the point in the room indicated by the position coordinates is transparent to be superimposed on the contour map or a frame-shaped icon in which, in a display area of the temperature changing point icon, a display area on the point in the room indicated by the position coordinates is hollowed out to be superimposed on the contour map, and
the processing circuitry changes a color of the temperature changing point icon when the operation of lowering the set temperature is accepted by the temperature setting device or the operation of raising the set temperature is accepted by the temperature setting device,
wherein the processing circuitry displays a sensible temperature icon indicating the sensible temperature estimated in the display area on the point in the room indicated by the position coordinates.
